(19) United States
(12) Patent Application Publication
(10) Pub. No.: US 2011/0149805 A1
(43) Pub. Date: Jun. 23, 2011

(54) NETWORK GROUP DETERMINATION DEVICE AND METHOD, AND STORAGE MEDIUM OF STORING NETWORK GROUP DETERMINATION PROGRAM

(75) Inventors: Takeshi Yasuie, Kawasaki (JP); Shunsuke Kikuchi, Kawasaki (JP); Yuji Nomura, Kawasaki (JP)

(73) Assignee: FUJITSU LIMITED, Kawasaki-shi (JP)

(21) Appl. No.: 12/970,204

(22) Filed: Dec. 16, 2010

(30) Foreign Application Priority Data
Dec. 21, 2009 (JP) 2009-289266

(51) Int. Cl. H04L 12/28

(52) U.S. Cl. 370/255

(57) ABSTRACT

A network group determination device includes an acquisition section, a comparison section and a determination section. The acquisition section acquires first communication information representing a state of communication between a first repeater on a network and a specific network group on the network, and second communication information representing a state of communication between a second repeater on the network and the network group. The comparison section makes a comparison of a difference between the first communication information and the second communication information to third communication information between the first repeater and the second repeater. The determination section makes, according to a result of the comparison by the comparison section, a determination of a position of the network group with respect to the first repeater and the second repeater.

### CROSS-REFERENCE TO RELATED APPLICATION

This application is based upon and claims the benefit of priority of the prior Japanese Patent Application No. 2009-289266, filed on Dec. 21, 2009, the entire contents of which are incorporated herein by reference.

### FIELD

The embodiments discussed herein are related to a network group determination device, a network group determination method, and a storage medium that stores a network group determination program.

### BACKGROUND

Conventionally, a computer network in which plural computers exchange information through communication is known. Such a computer network is a kind of communication network in a sense that computers communicate with each other. Further, when the computer network is regarded as a communication network, a communication location serving as an originating location or a receiving location of communication corresponds to not only each computer but an end subnet where plural computers are gathered. This communication location may be referred to below as a network group meaning a group made up of one or more computers existing on a network.

As represented by the Internet, the size of such a computer network has greatly increased in late years. As a result, the distribution of places where the computers on the computer network are physically installed has spread on a global scale and has reached a level of a company's departments or employees in terms of density. When maintenance and management of such a huge communication network is carried out, each communication location (network group) is a management object. In the maintenance and management, it is important to know an area where the management object is present on the communication network, but often, an administrator side is not informed of a geographical location where the management object is actually installed.

Thus, with regard to the operation management of the computer network, there has been proposed a technique in which based on a Hops number (the number of hops) of each of devices ranging from a newly introduced device to each area server, an area server with the smallest Hops number (the number of hops) is assumed to be an area server that performs operation management of this newly introduced device (for example, see Japanese Patent Laid-open Publication No. 2009-88676).

The Hops number is the number of relay nodes (namely, repeaters) by way of which communication information goes and thus, the Hops number represents a distance of communication on the communication network. This distance of communication may be regarded as a kind of communication state.

It is conceivable that the technique of Japanese Patent Laid-open Publication No. 2009-88676 will adequately function when the distribution of the computers on the computer network is geographically uniform and the computers geographically close to each other are mutually connected. However, generally, in a communication network, with the expansion of the network, the number of relays is often reduced by directly linking some relay nodes that are geographically far away from each other. When the technique of Japanese Patent Laid-open Publication No. 2009-88676 is applied to such a case, there is a possibility that locations that are geographically quite different from each other may be managed by being treated as one and the same area.

Thus, it is conceivable to divide the communication network into plural areas and thereby carry out management based on a topological way of thinking as described below. That is to say, the communication network is divided into plural areas within each of which network groups are interconnected via plural paths, but between which connection is established via a specific relay node on an area border.

It is conceivable that this area border may be produced when relay nodes geographically far away from each other are directly linked or when a link to a communication network is established beyond a geographical border such as a strait. For this reason, each of the areas split by this area border is expected to be united geographically as well. Besides, a location serving as this area border is also important on the communication network and thus, it is often easy to know beforehand this location including a geographical point on the administrator side. As a result, on the administrator side, it is conceivable to readily grasp the geographical position of each area.

In this way, it is conceivable that the area division based on the topological way of thinking may be suitable for understanding of a geographical structure of the communication network. Thus, what are desired are a method and a device, which may determine to which area each network group belongs, based on information available from the relay node on the area border.

### SUMMARY

According to an aspect of the invention, a network group determination device includes an acquisition section, a comparison section and a determination section. The acquisition section acquires first communication information which represents a state of communication between a first repeater on a network and a specific network group on the network, and second communication information which represents a state of communication between a second repeater on the network and the network group. The comparison section makes a comparison of a difference between the first communication information and the second communication information to third communication information between the first repeater and the second repeater. The determination section makes, according to a result of the comparison by the comparison section, a determination of a position of the network group with respect to the first repeater and the second repeater.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram that illustrates a specific first embodiment of the network group determination device;

FIG. 2 is a diagram that illustrates a specific first embodiment of the storage medium that stores the network group determination program;

FIG. 3 is a diagram for explaining the communication network;

FIG. 4 is a diagram that illustrates the specific first embodiment of the network group determination method;

FIG. 5 is a diagram that illustrates an area identifying device corresponding to the second embodiment of the network group determination device;

FIG. 6 is a diagram that illustrates the area identification program according to the second embodiment of the storage medium that stores the network group determination program;

FIG. 7 is a diagram that illustrates a structure of the flow-quality measuring device and a concept of the area division;

FIG. 8 is a diagram that illustrates a measurement concept of RTT;

FIG. 9 is a flow chart that represents a specific measuring method of measuring RTT by the flow-quality measuring device;

FIG. 10 is a diagram that illustrates a structure of the IP header;

FIG. 11 is a diagram that illustrates a structure of the TCP header;

FIG. 12 is a diagram that illustrates the session management table;

FIG. 13 is a diagram that illustrates an example of the flow quality information (measured data of RTT) stored in the flow-quality information storage section;

FIG. 14 is a flow chart that represents the operation of the area identification device;

FIG. 15 is an explanatory diagram regarding the RTT distribution;

FIG. 16 is a diagram that illustrates an example of the analysis result stored in the area-analysis result storage section;

FIG. 17 is a diagram for explaining the comparative example;

FIG. 18 is a diagram that illustrates an area identifying device corresponding to the third embodiment of the network group determination device;

FIG. 19 is a diagram that illustrates the area identification program according to the third embodiment;

FIG. 20 is a diagram that illustrates an example of the flow quality information stored in the flow-quality information storage section according to the third embodiment;

FIG. 21 is a flow chart that represents the operation of the area identification device of the third embodiment;

FIG. 22 is a diagram that illustrates an example of the analysis result stored in the quality-information-analysis result storage section according to the third embodiment;

FIG. 23 is a diagram that illustrates an example of the analysis result stored in the area-analysis result storage section according to the third embodiment;

FIG. 24 is a diagram that illustrates an area identifying device corresponding to the fourth embodiment of the network group determination device;

FIG. 25 is a diagram that illustrates the area identification program corresponding to the network group determination program according to the fourth embodiment;

FIG. 26 is a diagram that illustrates an example of the flow quality information stored in the flow-quality information storage section according to the fourth embodiment;

FIG. 27 is a flow chart that represents the operation of the area identification device of the fourth embodiment;

FIG. 28 is a diagram that illustrates an example of the analysis result stored in the quality-information-analysis result storage section according to the fourth embodiment;

FIG. 29 is a diagram that illustrates an example of the analysis result stored in the area-analysis result storage section according to the fourth embodiment;

FIG. 30 is a diagram that illustrates an area identifying device corresponding to the fifth embodiment of the network group determination device;

FIG. 31 is a diagram that illustrates the area identification program corresponding to the network group determination program according to the fifth embodiment;

FIG. 32 is a diagram that illustrates the concept of the area division in the fifth embodiment;

FIG. 33 is a diagram that illustrates an example of the flow quality information stored in the flow-quality information storage section according to the fifth embodiment;

FIG. 34 is a flow chart that represents the operation of the area identification device in the fifth embodiment;

FIG. 35 is a diagram that illustrates an example of the analysis result stored in the between-monitoring-points analysis-result storage section according to the fifth embodiment; and

FIG. 36 is a diagram that illustrates an example of the analysis result stored in the area-analysis result storage section according to the fifth embodiment;

FIG. 37 is a diagram that illustrates another style in the display of the analysis result by the result display section.

### DESCRIPTION OF EMBODIMENTS

Exemplary embodiments of a network group determination device, a network group determination method and a storage medium that stores a network group determination program will be described below.

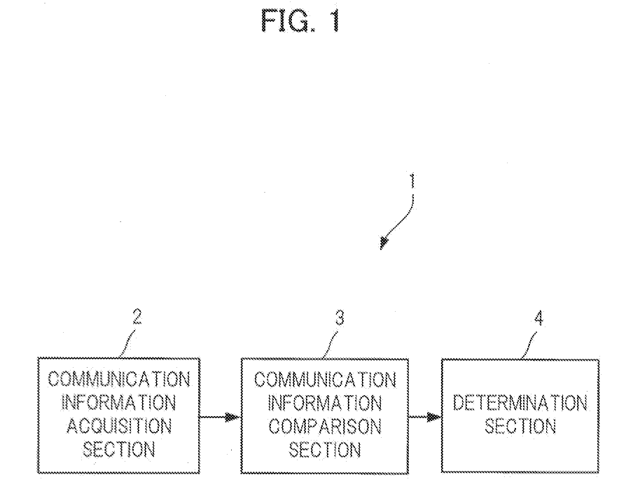

FIG. 1 is a diagram that illustrates a specific first embodiment of the network group determination device.

A network group determination device 1 includes a communication information acquisition section 2, a communication information comparison section 3 and a determination section 4. This network group determination device 1 is a computer that operates when a network group determination program is executed on the computer.

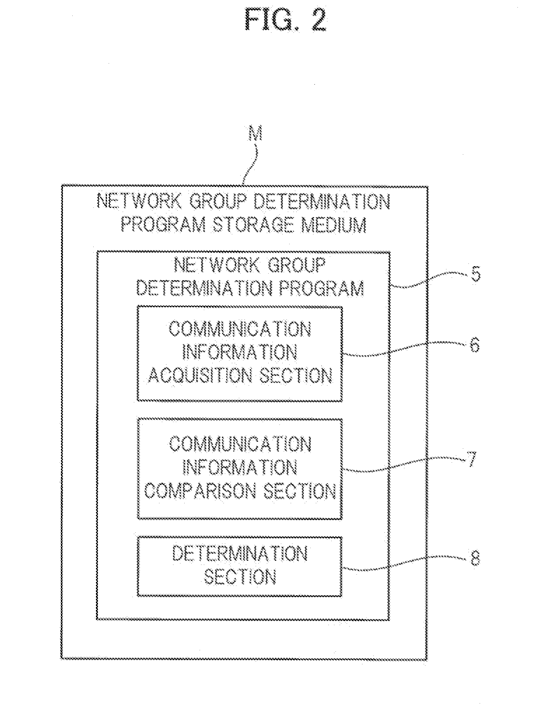

FIG. 2 is a diagram that illustrates a specific first embodiment of the storage medium that stores the network group determination program.

A network group determination program 5 illustrated in FIG. 2 is stored in a storage medium M. This network group determination program 5 is taken into the computer from the storage medium M.

This storage medium M may be anything that stores the network group determination program 5. The storage medium M may be, for example, a portable medium represented by a CD or a DVD, and may be a fixed medium represented by a magnetic disk incorporated into a hard disk drive. Further, this storage medium M may be a solid storage element represented by a USB memory.

Furthermore, the network group determination program 5 may be taken into the computer through a telecommunication network without going through the storage medium M.

The network group determination program 5 includes a communication information acquisition section 6, a communication information comparison section 7 and a determination section 8. When the network group determination program 5 is executed on the computer, the communication information acquisition section 6 causes the computer to operate as the communication information acquisition section 2 of the network group determination device 1 illustrated in FIG. 1. Likewise, the communication information comparison section 7 and the determination section 8 of the network group determination program 5 cause the computer to operate as the communication information comparison section 3 and the determination section 4 of the network group determination device 1, respectively.

The description will be continued by returning to FIG. 1.

The communication information acquisition section 2 acquires (obtains) the first communication information and the second communication information.

The first communication information is information that represents, with a numerical value, a distance of communication from one side to the other side between a first repeater and a specific communication location. This first communication information is information that represents a state of communication between the first repeater and the specific communication location (namely, a specific network group). Further, the first repeater is included in plural repeaters which divide a communication network into three or more areas and which relay the communication on a border between the areas formed by the division. Furthermore, the communication network includes plural communication locations (network groups) each of which becomes at least one of an originating location and a receiving location of the communication. Moreover, the specific communication location is determined from among these plural communication locations.

The second communication information is information that represents, with a numerical value, a distance of communication from one side to the other side between a second repeater and the specific communication location. This second communication information is information that represents a state of communication between the second repeater and the specific communication location. The second repeater is included in the above-mentioned plural repeaters.

Here, the communication network will be described.

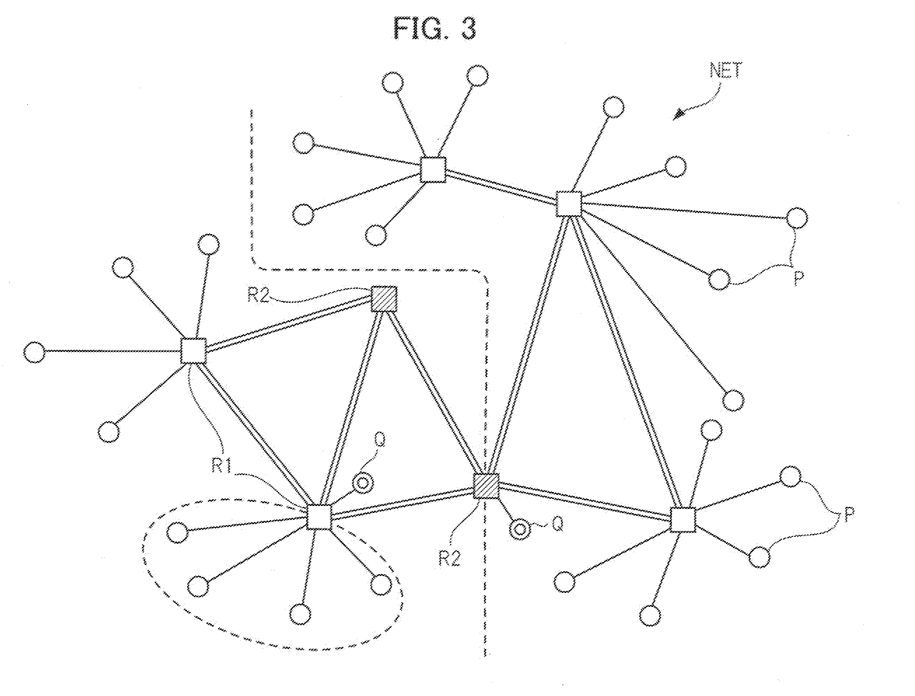

FIG. 3 is a diagram for explaining the communication network.

In FIG. 3, a communication network NET is extremely simplified and illustrated. This communication network NET includes a communication location P that is the communication location described above, and repeaters R1 and R2 that relay the communication.

Not only each computer but also an end subnet where plural computers are gathered correspond to the communication location P. For example, a Local Area Network (LAN) or the like formed by computers for one floor of a company corresponds to the end subnet.

As the repeaters R1 and R2, there are the repeater R1 directly connected to the communication location P and the repeater R2 connected to other repeaters R1 and R2 without being directly connected to the communication location P. The repeater R1 directly connected to the communication location P serves as an entrance to the communication network NET. On the other hand, the repeater R2 connected only to other repeaters R1 and R2 solely serves to relay the communication. Among these two kinds of repeaters R1 and R2, the repeater R1 directly connected to the communication location P is a device available as a repeater on the area border (namely, the first repeater or the second repeater). This is because the communication location connected to this repeater R1 is not connected to other repeaters R1 and R2, and in this sense, the communication location connected to this repeater R1 is distinguished from other part of the communication network NET. A lower left part surrounded by a dotted line in FIG. 3 is an example of such a distinguished area. Further, even in the case of the repeater R2 connected only to other repeaters R1 and R2, there is a case in which the repeater R2 becomes a repeater on the area border indicated by a dotted line illustrated in the center of FIG. 3. This is because it is difficult for the left and right areas in FIG. 3 to communicate with each other without going through the repeater R2 on the dotted line.

In the present disclosure, the areas is assumed by understanding the structure of the communication network based on the topological way of thinking in this way. Further, as the first communication information and the second communication information, for example, a Round Trip Time (RTT) and a Hops number are available. Such information may be obtained by measurement or the like of communication data that has passed through the repeaters R1 and R2 on the area border. For this reason, a measuring device Q is connected to the repeater R1 or R2 on the communication network NET illustrated in FIG. 3, to obtain the first communication information or the second communication information.

The communication information comparison section 3 illustrated in FIG. 1 compares a difference between the first communication information and the second communication information with the third communication information that represents, with a numerical value, a distance of communication from one of the first repeater and the second repeater to the other. This third communication information is also information that represents a state of the communication between the first repeater and the second repeater.

Based on a result of the comparison by the communication information comparison section 3, the determination section 4 determines the position of the specific communication location with respect to the first repeater and the second repeater. The determination section 4 in the present embodiment determines, in particular, an area where the specific communication location among the three or more areas is present.

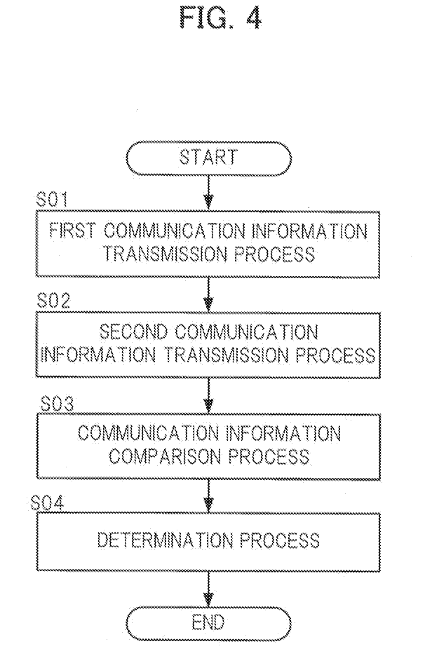

When such a network group determination device 1 illustrated in FIG. 1 is connected to the measuring device Q on the communication network NET illustrated in FIG. 4, a specific first embodiment of the network group determination method is executed.

FIG. 4 is a diagram that illustrates the specific first embodiment of the network group determination method.

The first embodiment of the network group determination method includes a first communication information transmission process S01, a second communication information transmission process S02, a communication information comparison process S03, and a determination process S04.

The first communication information transmission process S01 is a process in which a first measuring device that measures a state of the communication between the first repeater and the specific communication location transmits the first communication information that represents the state of the communication to the network group determination device 1. More specifically, the first measuring device measures a distance of communication from one of the first repeater and the specific communication location to the other. Further, the first measuring device transmits the first communication information to the communication information acquisition section 2 of the network group determination device 1.

The second communication information transmission process S02 is a process in which a second measuring device that measures a state of communication between the second repeater and the specific communication location transmits the second communication information that represents the state of the communication to the network group determination device 1. More specifically, the second measuring device measures a distance of communication from one of the second repeater and the specific communication location to the other. Further, the second measuring device transmits the second communication information to the communication information acquisition section 2 of the network group determination device 1.

The communication information comparison process S03 is a process in which the network group determination device 1 compares the difference between the first communication information and the second communication information with the third communication information. More specifically, the communication information comparison section 3 of the network group determination device 1 performs the comparison.

The determination process S04 is a process in which according to a result of the comparison in the communication information comparison process S03, the network group determination device 1 determines the position of the specific communication location with respect to the first repeater and the second repeater. More specifically, the determination section 4 of the network group determination device 1 determines the area where the specific communication location is present, from among the three or more areas.

It may be expected that in the communication that has passed through both of the first repeater and the second repeater, the difference between the first communication information and the second communication information will approximately agree with the third communication information. For this reason, when the result of the comparison by the communication information comparison section 3 is used, a path of the communication may be easily discriminated and thus, area determination also is easy. Incidentally, a result of the determination in the determination process S04 and the determination section 4 may be displayed on a display screen as information to be referred to by the maintenance manager of the communication network, or may be internally used as information to be used by software and the like for the maintenance and management.

Next, a specific second embodiment for the network group determination device, the network group determination method and the storage medium that stores the network group determination program which are described above with respect to the basic mode will be described as follows.

This second embodiment is equivalent to an example of each of the following first and second application modes which are preferable with respect to the above-described basic mode.

With respect to the basic mode, the first application mode, in which the first communication information, the second communication information and the third communication information are Round Trip Times (RTT), is preferable.

The information called RTT used in this first application mode is information in which the length of a path actually used in communication is finely reflected. Therefore, according to this first application mode, the comparison in the communication information comparison process and the communication information comparison section is made strict and thus, correct area determination is expected.

With respect to the basic mode, the second application mode, in which a display section that displays a result of the determination by the determination section is further provided, is preferable. According to this second application mode, the result of the determination is readily checked.

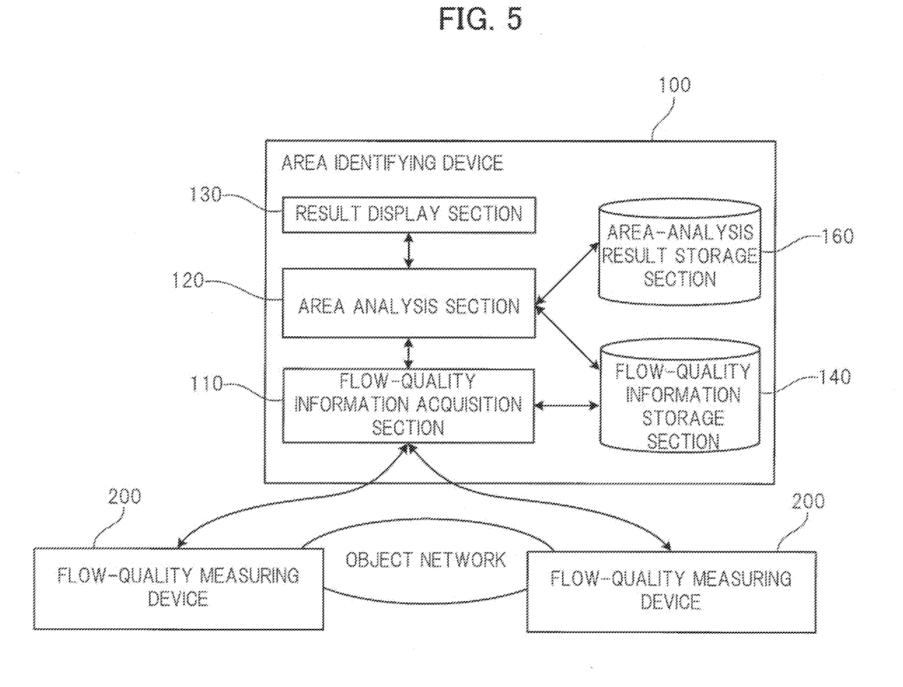

FIG. 5 is a diagram that illustrates an area identifying device corresponding to the second embodiment of the network group determination device.

This area identifying device (100) is connected to plural flow-quality measuring devices 200. The plural flow-quality measuring devices 200 are connected to an object network that is an object of area identification. In the present embodiment, this object network is a computer network that is a kind of communication network. This object network performs data communication in accordance with TCP/IP protocol.

Although details will be described later, the flow-quality measuring device 200 is a device that measures RTT as flow quality in the communication performed on the object network. Each of the plural flow-quality measuring devices 200 illustrated in FIG. 5 is equivalent to an example of each of the first measuring device and the second measuring device.

The area identifying device 100 includes a flow-quality information acquisition section 110, an area analysis section 120, a result display section 130, a flow-quality information storage section 140, and an area-analysis result storage section 160. Although illustration is not provided in particular, as hardware of this area identifying device 100, a general-purpose computer including a CPU, a memory, an HDD, a display, a communication circuit and the like is used. When an area identification program to be described later is executed on this computer, this computer operates as the area identification device 100.

In terms of hardware, the communication circuit of the computer mainly corresponds to the flow-quality information acquisition section 110 among the elements of the area identifying device 100. Further, the CPU corresponds to the area analysis section 120 in terms of hardware. Furthermore, the display mainly corresponds to the result display section 130 in terms of hardware. Still furthermore, the HDD corresponds to the flow-quality information storage section 140 and the area-analysis result storage section 160 in terms of hardware.

The flow-quality information acquisition section 110 collects measured data of RTT from each of the plural flow-quality measuring devices 200. This flow-quality information acquisition section 110 is equivalent to an example of the acquisition section in the basic mode. The measured data of RTT collected by the flow-quality information acquisition section 110 is stored in the flow-quality information storage section 140.

The area analysis section 120 analyzes an area to which the specific communication location belongs, based on the measured data of RTT stored in the flow-quality information storage section 140. The analysis by this area analysis section 120 will be described later more in detail. This area analysis section 120 is equivalent to an example serving as the comparison section and the determination section in the above-described basic mode. An analysis result obtained by the area analysis section 120 is stored in the area-analysis result storage section 160.

The result display section 130 displays the analysis result stored in the area-analysis result storage section 160. This result display section 130 is equivalent to an example of the display section in the second application mode.

Here, the area identification program that causes the computer to operate as the area identifying device 100 will be described. This area identification program is in the second embodiment of the storage medium that stores the network group determination program.

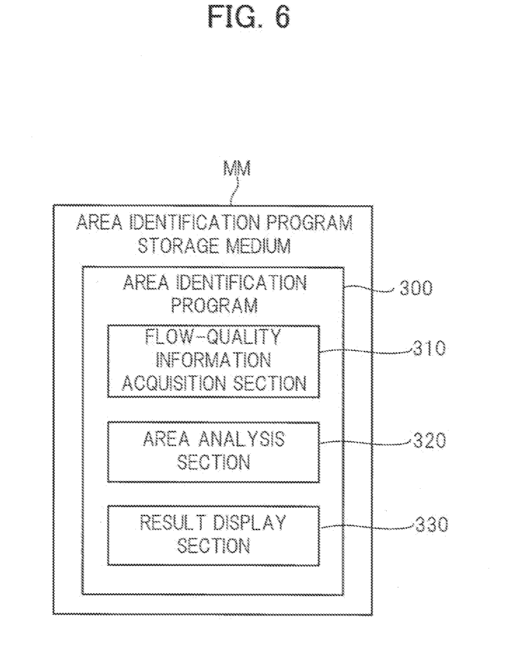

FIG. 6 is a diagram that illustrates the area identification program according to the second embodiment of the storage medium that stores the network group determination program.

This area identification program 300 is stored in an area-identification program storage medium MM. The area identification program 300 is taken into the computer from the area-identification program storage medium MM.

This area-identification program storage medium MM may be anything that stores the area identification program 300. The area-identification program storage medium MM may be, for example, a portable medium represented by a CD or a DVD, and may be a fixed medium represented by a magnetic disk incorporated into a hard disk drive. Further, this storage medium MM may be a solid storage element represented by a USB memory.

Furthermore, the area identification program 300 may be taken into the computer through a telecommunication network without going through a storage medium.

As illustrated in FIG. 6, the area identification program 300 includes a flow-quality information acquisition section 310, an area analysis section 320, and a result display section 330. The flow-quality information acquisition section 310 of this the area identification program 300 causes the computer to operate as the flow-quality information acquisition section 110 of the area identification device 100. The area analysis section 320 of the area identification program 300 causes the computer to operate as the area analysis section 120 of the area identification device 100. The result display section 330 of the area identification program 300 causes the computer to operate as the result display section 130 of the area identifying device 100.

Next, the flow-quality measuring device and the like illustrated in FIG. 5 will be described more in detail.

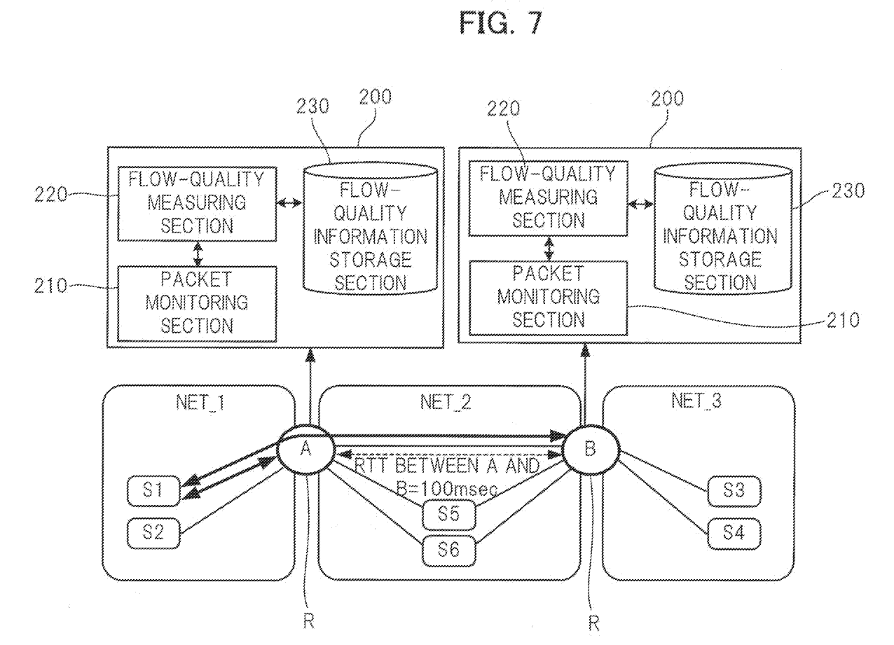

FIG. 7 is a diagram that illustrates a structure of the flow-quality measuring device and a concept of the area division.

The flow-quality measuring device 200 is connected to a repeater R on the object network. This repeater R is the repeater existing on the area border as described with reference to FIG. 3. The object network is divided into three net areas of “NET_1”, “NET_2” and “NET_3” by the two repeaters R illustrated in FIG. 7. In the present embodiment, an end subnet is assumed to be a communication location in which the object network is present. In FIG. 7, six end subnets S1 through S6 are illustrated as an example. Communication between the end subnets which belong to different net areas is desired to pass through the repeater R on the area border. The flow-quality measuring devices 200 measure RTT for the end subnets S1 through S6, by monitoring the communication passing through the repeaters R. The repeater R to which the flow-quality measuring device 200 is connected may be referred to as a network monitoring point, meaning a location to be thus monitored. Further, when the two repeaters R illustrated in FIG. 7 are distinguished from each other, the repeater R illustrated on the left side of FIG. 7 is referred to as a repeater “A”, while the repeater R illustrated on the right side of FIG. 7 is referred to as a repeater “B”.

Among the three net areas illustrated in FIG. 7, the net area “NET_1” on the left end in FIG. 7 is in a state of being separated from other part of the object network by the repeater “A” and thus, such a net area will be referred to as an end area of the repeater “A” in the following. Likewise, the net area “NET_3” on the right end in FIG. 7 is an end area of the repeater “B”. The net area “NET_2” on the middle of FIG. 7 is not the end area of either repeater.

The flow-quality measuring device 200 includes a packet monitoring section 210, a flow-quality measuring section 220 and a flow-quality information storage section 230. The packet monitoring section 210 is a communication device that obtains a copy of a communication packet from a monitoring port originally provided in the repeater R. The flow-quality measuring section 220 is a computing device that measures RTT with a technique that will be described below. The flow-quality information storage section 230 is an information storage device that stores measured data of RTT obtained as a result of the measurement by the flow-quality measuring section 220.

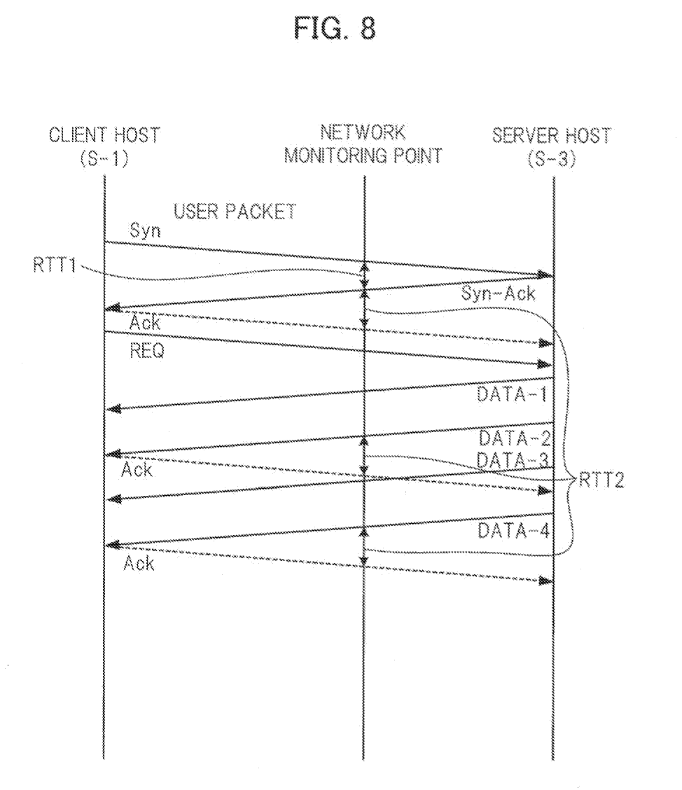

FIG. 8 is a diagram that illustrates a measurement concept of RTT.

FIG. 8 illustrates an example in which communication is performed, by way of a network monitoring point, between a client host included in an end subnet “S-1” and a server host included in an end subnet “S-3”. The communication is executed through exchanges of user packets (namely, communication packets). At the start of the communication, a so-called three way handshake is performed between the client host and the server host. In other words, a Syn packet is sent from the client host to the server host, and a Syn-Ack packet is sent from the server host to the client host in response to the Syn packet. Further, an Ack packet is sent from the client host to the server host in response to the Syn-Ack packet. It may be assumed that there is almost no delay between the arrival of the Syn packet in the server host and the transmission of the Syn-Ack packet. Therefore, time “RTT1” from the passage of the Syn packet through the network monitoring point to the passage of the Syn-Ack packet through the network monitoring point represents a “distance of communication” between the network monitoring point and the server host.

Likewise, time “RTT2” from the passage of the Syn-Ack packet through the network monitoring point to the passage of the Ack packet through the network monitoring point represents a “distance of communication” between the network monitoring point and the client host.

Thus, a lapse of time from the passage of a “going” packet through the network monitoring point to the passage of a “returning” packet through the network monitoring point is RTT.

Incidentally, the “RTT2” that represents the “distance of communication” between the network monitoring point and the client host may be measured by a combination of a data packet sent from the server host and the Ack packet returning from the client host.

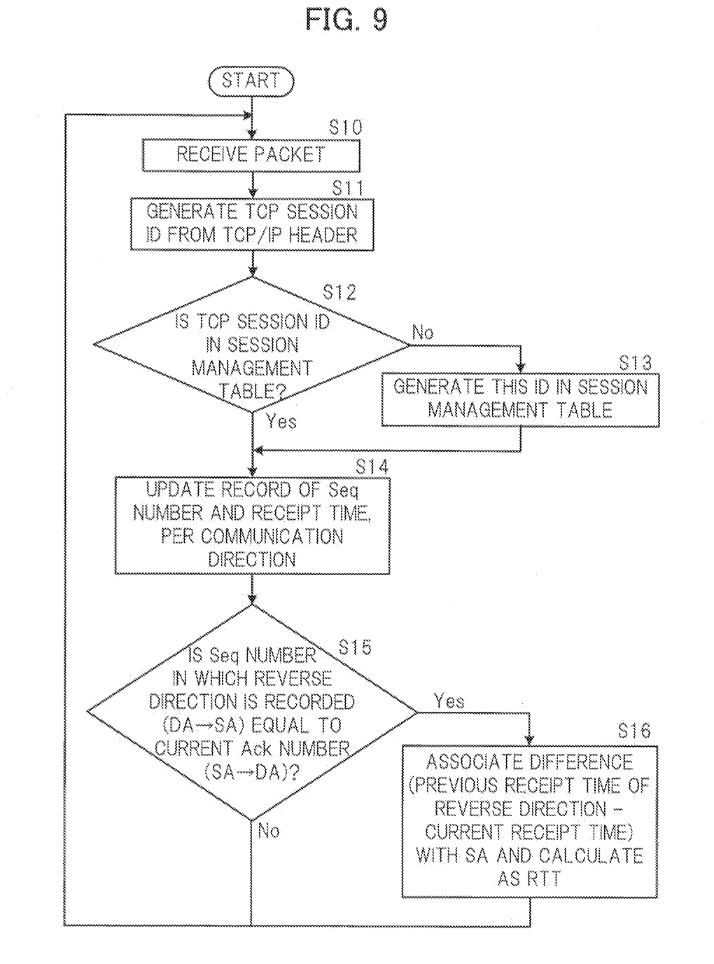

FIG. 9 is a flow chart that represents a specific measuring method of measuring RTT by the flow-quality measuring device.

At first, in the measurement of RTT, the packet monitoring section 210 of the flow-quality measuring device 200 receives a copy of the communication packet from the repeater R in step S10. Subsequently, the flow-quality measuring section 220 of the flow-quality measuring device 200 uses information in a TCP/IP header of the communication packet in step S11, thereby generating a TCP session ID. Each step after this step S11 is executed by the flow-quality measuring section 220.

Here, the TCP/IP header will be briefly described.

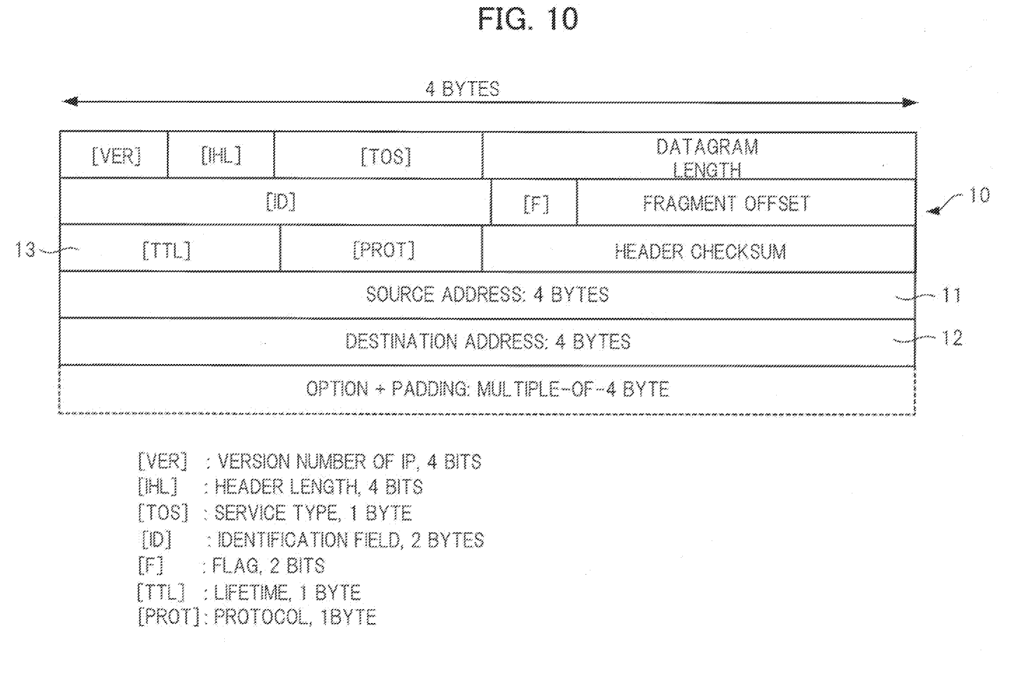

FIG. 10 is a diagram that illustrates a structure of the IP header.

In FIG. 10, an IP header 10 in a state of being divided per four bytes is illustrated. The upper part of FIG. 10 is the leading side of a packet and the left side of FIG. 10 also is the leading side of the packet. In other words, the right end of a certain stage is connected to the left end of a stage next to (below) the stage.

The IP header 10 includes various kinds of information as illustrated in FIG. 10, but what are related to creation of the TCP session ID are a Source Address (SA) 11 and a Destination Address (DA) 12. Incidentally, a life time (Time To Live: TTL) 13 is not used in the present embodiment, but is used in another embodiment that will be described later.

Each of the source address 11 and the destination address 12 is a so-called IP address. Generally, this IP address is expressed by a row of four integer values each of which is 255 or below (namely, a value expressed by one byte).

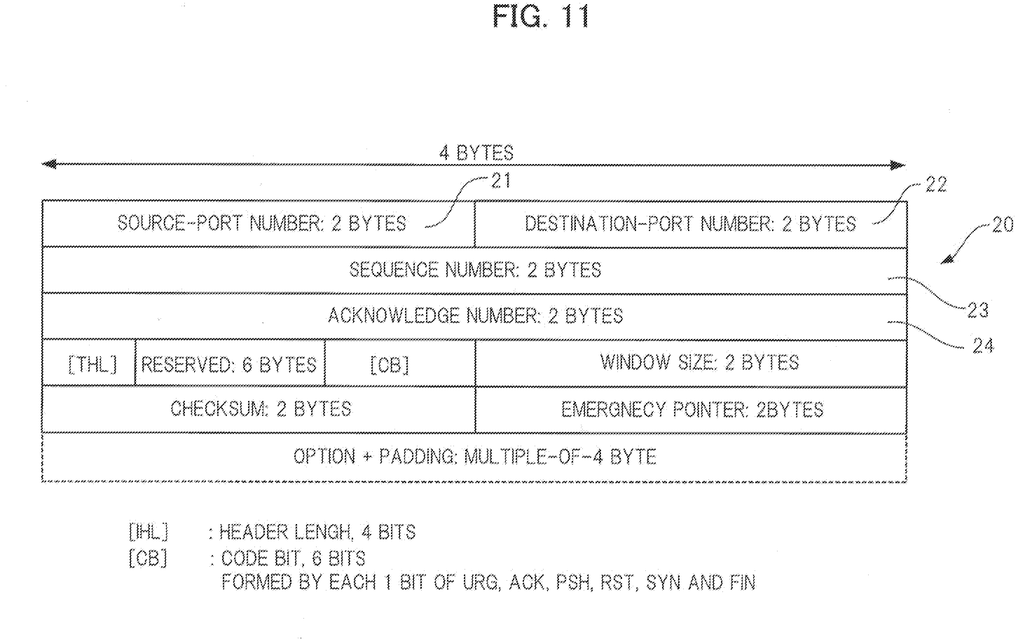

FIG. 11 is a diagram that illustrates a structure of the TCP header.

In FIG. 11 as well, a TCP header 20 in a state of being divided per four bytes is illustrated. The upper part of FIG. 11 is the leading side of a packet and the left side of FIG. 11 also is the leading side of the packet. In other words, the right end of a certain stage is connected to the left end of a stage next to (below) that stage.

The TCP header 20 includes various kinds of information illustrated in FIG. 11, but what are related to creation of the TCP session ID are a Source Port (SP) number 21 and a Destination Port (DP) number 22. Further, a sequence-number 23 and an acknowledge (Ack) number 24 are pieces of information used in the measurement of RTT which will be described later.

As the TCP session ID, a unique ID is given to what is subjected to sorting of the source address 11 and the destination address 12 in each session. Thus, the same ID is given to the “going” packet and the “returning” packet. To be more specific, at first, the size of the destination address (DA) 12 and the size of the source address (SA) 11 are compared with each other. Further, when SA>DA, a 12-byte number in which SA, SP, DA and DP are aligned is the TCP session ID. On the other hand, when SA<DA, a 12-byte number in which DA, DP, SA and SP are aligned is the TCP session ID. Incidentally, a state in which SA=DA is unrealistic and thus is not be considered in the present embodiment.

When such a TCP session ID is generated in step S11 of FIG. 9, the flow-quality measuring section 220 refers to a session management table in the next step S12. This session management table is stored in the flow-quality information storage section 230 of the flow-quality measuring device 200.

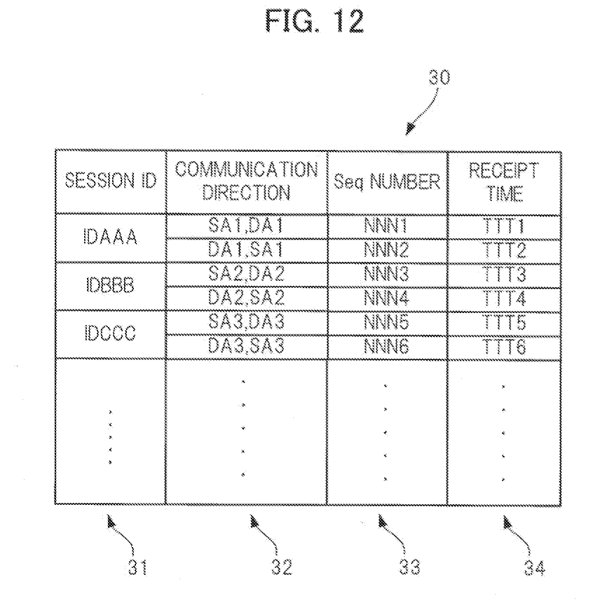

FIG. 12 is a diagram that illustrates the session management table.

In this session management table 30, a TCP session ID 31, communication direction information 32, a sequence number 33 and a receipt time 34 are stored.

The TCP session ID 31 is an ID generated in step S11 of FIG. 9 as described above.

As a result of referring to the session management table 30 in step S12 of FIG. 9, when there is no ID identical to the TCP session ID generated in step S11, the ID is newly stored in the session management table 30 (step S13). Also, SA and DA obtained from the packet at the time are used, and the communication direction information 32 of each of both forward and reverse directions is generated. In other words, an 8-byte number in which DA and SA are aligned and an 8-byte number in which SA and DA are aligned are associated with one TCP session ID 31, and stored.

After step S13, the flow proceeds to step S14. Incidentally, when there is an ID identical to the TCP session ID in step S12, the flow proceeds from step S12 to step S14 directly.

In step S14, the sequence-number 23 obtained from the TCP/IP header of the communication packet and the time at which the communication packet is received (relayed) by the repeater R are stored in the session management table 30 as the sequence number 33 and the receipt time 34. These sequence number 33 and the receipt time 34 are associated with the communication direction information 32 identical to the row of SA and DA obtained from the TCP/IP header of this communication packet, and stored. Further, when there are the sequence number 33 and the receipt time 34 already stored, the information is overwritten.

Subsequently, the flow advances to step S15 where the other sequence number 33 corresponding to the TCP session ID 31 with which the sequence number 33 stored in step S14 is associated (namely, the sequence number 33 in the reverse direction) is compared with the acknowledge number 24 obtained from the header of the current communication packet.

When the numbers do not agree with each other as a result of this comparison (step S15: No), the sessions are different and thus, the processing returns to step S10. On the other hand, when the numbers agree with each other (step S15: Yes), the going and returning packets of the same session are obtained and thus, a difference between the receipt time 34 in the forward direction and the receipt time 34 in the reverse direction is calculated as RTT in step S16.

The calculated RTT is stored in the flow-quality information storage section 230, as the measured data of RTT for the end subnet identified by the source address 11 obtained from the header of the current communication packet. In the present embodiment, the end subnet is identified by high-order 3 bytes of the source address 11. Incidentally, when plural pieces of measured data are obtained for one end subnet, for example, a mean value may be calculated or a minimum value may be adopted.

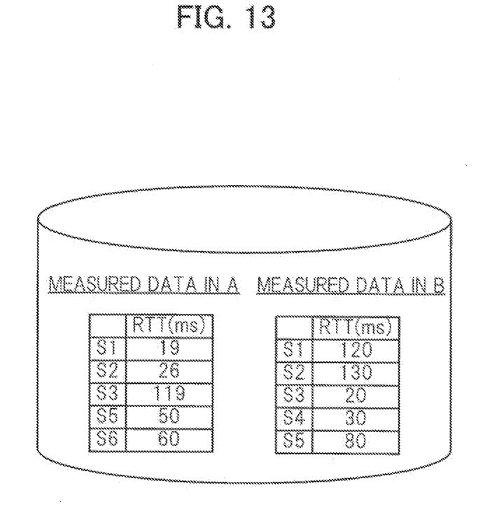

FIG. 13 is a diagram that illustrates an example of the flow quality information (measured data of RTT) stored in the flow-quality information storage section.

FIG. 13 illustrates the flow quality information (measured data of RTT) collected in the flow-quality information storage section 140 of the area identification device 100 illustrated in FIG. 5, from the flow-quality information storage section 230 of each of the flow-quality measuring devices 200 illustrated in FIG. 7. In the flow-quality information storage section 230 of each of the flow-quality measuring devices 200, either the measured data in the repeater “A” or the measured data in the repeater “B” is stored, of the measured data illustrated here.

As illustrated in FIG. 13, the measured data of RTT is stored as a table in which pieces of the data are associated with the end subnets S1 through S6. Further, in the example illustrated in here, there is no measured data of the end subnet S6 among the measured data in the repeater “B”, and there is no measured data of the end subnet S4 among the measured data in the repeater “A”. This merely indicates that the measured data has not been obtained in the measurement in each of the repeaters by chance, and theoretically, the measurement may be performed for either repeater and for any of the end subnets S1 through S6.

Next, operation for identifying areas of the end subnets S1 through S6 by the area identifying device 100 illustrated in FIG. 5 will be described in detail.

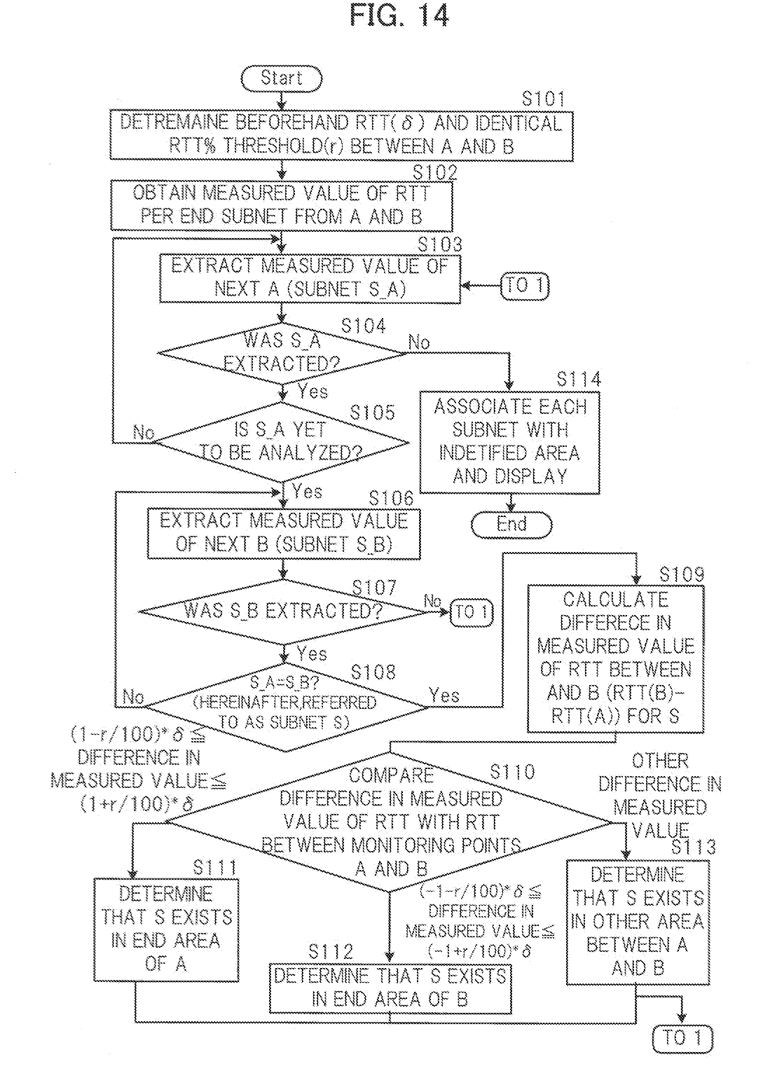

FIG. 14 is a flow chart that represents the operation of the area identification device.

This flow chart also represents the second embodiment of the network group determination method.

At first, in step S101, a measured value δ of RTT between the repeater “A” and the repeater “B”, which is measured beforehand, is stored in the flow-quality information storage section 140.

As a method of measuring this measured value δ, it is conceivable to use a method of measuring a round-trip time by causing a communication packet for the measurement to make a round trip between these repeaters, but the method of measuring the measured value δ is not limited to this method. Further, the measurement of the measured value δ is carried out by a user of the area identifying device 100 by use of an arbitrary technique. In step S101, a threshold r (%) that represents an error tolerance in which the value may be assumed to be “substantially the same” also is stored in the flow-quality information storage section 140 at the time of comparison in step S110 that will be described later. The calculation of this threshold r also is carried out by the user of the area identifying device 100 by use of an arbitrary technique. A method of calculating this threshold r will be described later.

In the next step S102, the measured data of RTT is transmitted from the flow-quality measuring device 200 connected to each of the repeaters, and the transmitted measured data is acquired by the flow-quality information acquisition section 110. The acquired measured data is stored in the flow-quality information storage section 140 as described above.

Afterwards, processing in each of step S103 through step S113 is executed by the area analysis section 120 of the area identifying device 100. In step S103, the measured data in the repeater “A” is read from the flow-quality information storage section 140. Reading out of the measured data in step S103 is performed, by one stage, sequentially from upper part of the table illustrated in FIG. 13, every time step S103 is executed. When the measured data has been read in step S103, in other words, when the next stage exists (step S104: Yes), it is checked whether an area of an end subnet (S_A) with which the measured data of the stage is associated has not yet been analyzed in step S105. This checking is based on whether or not an analysis result is stored in the area-analysis result storage section 160 of the area identifying device 100. As a result of the checking in step S105, when the net area has been analyzed, the processing returns to step S103.

As a result of the checking in step S105, when the net area has not yet been analyzed, the measured data in the repeater “B” is read from the flow-quality information storage section 140 in the next step S106. Reading out of the measured data in step S106 also is performed, by one stage, sequentially from upper part of the table illustrated in FIG. 13, every time step S106 is executed.

When the measured data has been read in step S106 (step S107: Yes), the flow advances to step S108. In step S108, it is checked whether an end subnet (S_B) corresponding to the measured data of that stage and the end subnet (S_A) whose measured data has been read in step S108 are identical. Until S_B and S_A agree with each other in step S108, the processing in step S106 through step S108 is repeated. Further, when there is no next stage in the table illustrated in FIG. 13 while S_A and S_B do not agree with each other (step S107: No), the processing returns to step S103.

When S_B and S_A agree with each other in step S108, a difference of the measured data of RTT is calculated for the end subnet S in step S109. The sign of this difference will have a role later and thus, the difference is determined by subtracting the measured data in the repeater “A” from the measured data in the repeater “B” in step S109. In the next step S110, the difference calculated in this way is compared with the measured value δ stored in the flow-quality information storage section 140 in step S101. In this comparison, the threshold r (%) also is used.

As a result of the comparison in step S110, when (1−r/100)*δ≦difference≦(1+r/100)*δ is satisfied, it is determined that a net area to which the end subnet S belongs is “NET_1” (step S111). In this case, an absolute value of the difference of the measured data “substantially agrees” with the RTT measured value between the repeater “A” and the repeater “B”. Further, the fact that the absolute value “substantially agrees” means that the end subnet belongs to the end area of either repeater as indicated by a thick arrow in FIG. 7. Furthermore, the sign of the difference of the measured data represents to which end area the end subnet belongs. In the present embodiment, the area of an end subnet is identified based on such a determination principle.

Here, a method of determining the threshold r (%) will be described.

Generally, the lager the RTT is, the greater the fluctuation of the measured data of RTT is. Further, a determination result, in which the end subnet belongs to the end area, increases as the threshold r is set to be larger. On the contrary, the determination result, in which the end subnet belongs to the end area, decreases as the threshold r is set to be smaller. When the area analysis is actually carried out by use of the measured data of RTT on a certain real communication network, in a case in which 5% is set as the threshold r, the percentage of a result, in which the end subnet belonging to the end area is erroneously determined as the end subnet not belonging to the end area, is around 10%. Also, the percentage of a result, in which the end subnet that does not belong to the end area is erroneously determined as the end subnet belonging to the end area, also is around 10%. Thus, it is empirically known that when the threshold r in which the percentages of incorrect determination agree with each other is adopted, the percentage of incorrect determination as a whole is small and therefore, it is conceivable that it may be effective to decide that the threshold r is 5%.

Further, it is also conceivable to determine the threshold r by using a statistical method based on an RTT distribution.

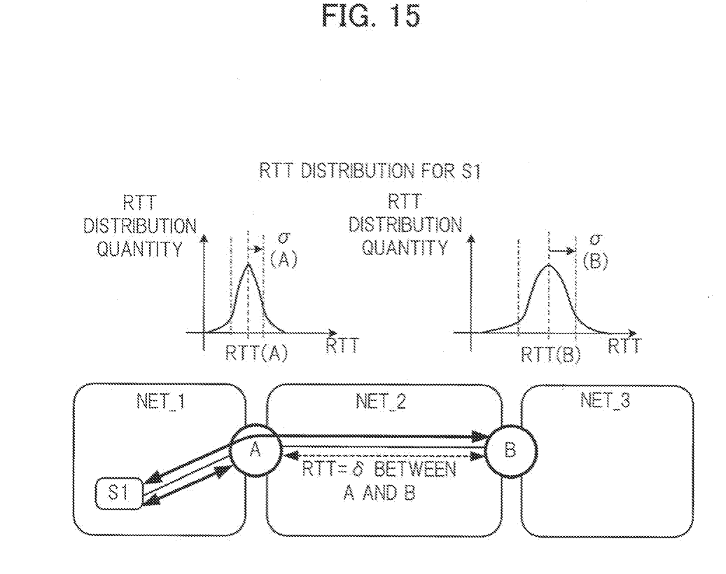

FIG. 15 is an explanatory diagram regarding the RTT distribution.

The distribution of RTT is determined by repeating the measurement of RTT many times, with each of the repeaters “A” and “B”, for the known end subnet S1 that is already present in a certain end area (“NET_1” in the example of FIG. 15). Two distribution curves illustrated in an upper part of FIG. 15 represent the distributions of RTT thus determined. Further, a variance (σ²) of RTT is calculated for each of the distribution curves. Statistically, it may be expected that about 95% of the measured values of RTT fall within a range of mean value ±σ of RTT and therefore, an appropriate area analysis may be expected by determining an upper limited to the threshold of the difference as δ+1.96*(σ(A)+σ(B)) and a lower limited to the threshold as δ−1.96*(σ(A)+σ(B)).

The description will be continued by returning to the flow chart in FIG. 14.

When, as a result of the comparison in step S110, (−1−r/100)*δ≦difference≦(−1+r/100)*δ is satisfied, the net area to which the end subnet S belongs is identified as “NET_3” based on the above-described determination principle (step S112).

When, as a result of the comparison in step S110, neither of the two equations described above is satisfied, the net area to which the end subnet S belongs is identified as “other area (namely, here, “NET_2”) based on the above-described determination principle (step S113).

The net area thus identified in step S111 through step S113 is associated with the end subnet S and stored in the area-analysis result storage section 160. When the net area is identified in step S111 through step S113, the processing returns to step S103.

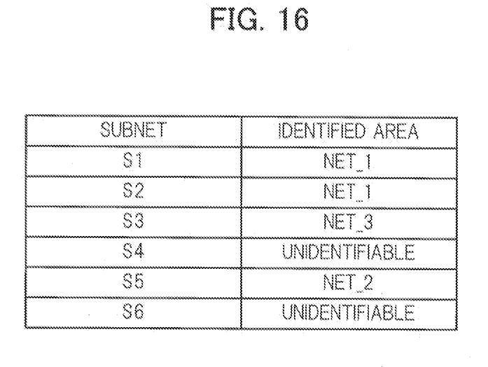

FIG. 16 is a diagram that illustrates an example of the analysis result stored in the area-analysis result storage section.

In the area-analysis result storage section 160, as illustrated in FIG. 16, an analysis result in a form of a table in which the end subnets and the identified areas are associated with each other is stored. As a table with initial values before starting the flow chart illustrated in FIG. 14, a table in which all the end subnets with measured data stored in the flow-quality information storage section 140 are indicated is prepared for. All the identified areas in the table with the initial values are “unidentifiable”. As to the end subnet for which the net area is identified in step S111 through step S113 illustrated in FIG. 14, the identified area in this table is overwritten.

The example of the analysis result illustrated in FIG. 16 corresponds to a result obtained by the analysis of the net area according to the flow chart illustrated in FIG. 14, based the example of the measured data illustrated in FIG. 13. Each end subnet will be described below in detail.

About δ and r that are preconditions of the analysis, it is assumed here that δ=100 ms, r=5%.

In the case of the end subnet S1, the calculation results in the difference=120−19=101 based on the measured data illustrated in FIG. 13. The absolute value of the difference falls within the error tolerance of 5% with respect to δ, and the sign of the difference is positive and therefore, the net area to which the end subnet S1 belongs is identified as “NET_1”.

In the case of the end subnet S2, the calculation results in the difference=130−26=104 based on the measured data illustrated in FIG. 13. The absolute value of the difference falls within the error tolerance of 5% with respect to δ, and the sign of the difference is positive and therefore, the net area to which the end subnet S2 belongs also is identified as “NET_1”.

In the case of the end subnet S3, the calculation results in the difference=20−119=−99 based on the measured data illustrated in FIG. 13. The absolute value of the difference falls within the error tolerance of 5% with respect to δ, and the sign of the difference is negative and therefore, the net area to which the end subnet S3 belongs is identified as “NET_3”.

In the case of the end subnet S5, the calculation results in the difference=80−50=30 based on the measured data illustrated in FIG. 13. The absolute value of the difference does not fall within the error tolerance of 5% with respect to δ and therefore, the net area to which the end subnet S5 belongs is identified as “NET_2”.

In this example, identification is not performed for the end subnet S4 whose measured data is not in the table of the repeater “A” illustrated in FIG. 13 and the end subnet S6 whose measured data is not in the table of and the repeater “B”.

When the net area of each end subnet is identified by repeating the processing of step S103 through step S113 illustrated in FIG. 14, the measured data in the repeater “A” runs out eventually (step S104: No). Afterwards, in step S114, the table as illustrated in FIG. 16 is displayed by the result display section 130 as the result of the area analysis.

A comparative example with respect to the above-described second embodiment will be described as follows.

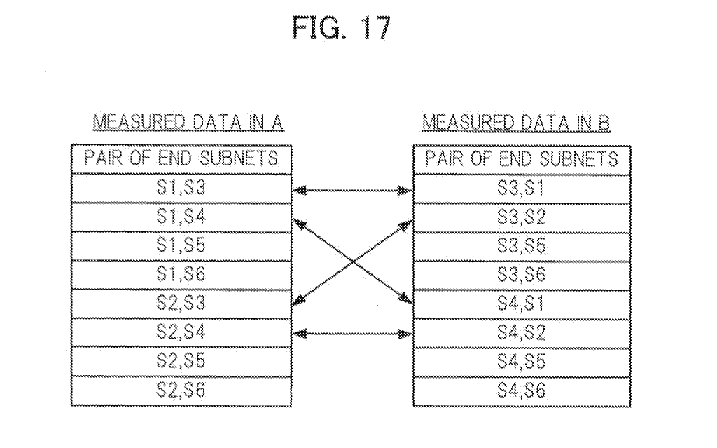

FIG. 17 is a diagram for explaining the comparative example.

In this comparative example, by using a source address and a destination address of a communication packet passing through each repeater, a pair of an end subnet on a source side and an end subnet on a destination side is determined. As illustrated in FIG. 17, a table of the end subnet pairs is created for every repeater.

By comparing the thus-created tables of the end subnet pairs with each other, the identical end subnet pairs existing in both tables (the order of the end subnets is ignored) are extracted. Of the thus-extracted end subnet pair, either one of the end subnets is present in the end area “NET_1” of the repeater “A”, and the other is present in the end area “NET_3” of the repeater “B”. For example, the end subnet pair formed by the end subnets “S1 and S3” is present in both tables and thus, the two end subnets S1 and S3 forming this pair are present in different end areas.

Further, as for the end subnet pair existing in only one table, for example, in the case of “S1, S5” in the table of the repeater “A”, the end subnet S5 is identified as belonging to the net area “NET_2” that is not the end area. Also, the end subnet S1 of the two end subnets S1, S3 is identified as belonging to the end area “NET_1” of the repeater “A”.

In this way, the net area to which each end subnet belongs may be identified in this comparative example as well. However, in this comparative example, when the numbers of the end subnets existing in both net areas sandwiching the repeaters are expressed by x, y, the number of the end subnet pairs described in the table is (x*y). Here, the number of the end subnet pairs in the repeater “A” is expressed by (x_A*y_A), and the number of the end subnet pairs in the repeater “B” is expressed by (x_B*y_B). Then, a calculation amount of (x_A*y_A)*(x_B*y_B) is desirable for the comparison of the end subnet pairs. Such a calculation amount imposes a too much calculation load and thus is not realistic.

With respect to the comparative example, in the second embodiment, the number of pieces of measured data described in the table as illustrated in FIG. 13 is (x+y). Here, the number of pieces of measured data in the repeater “A” is expressed by (x_A+y_A), and the number of pieces of measured data in the repeater “B” is expressed by (x_B+y_B). Then, the calculation amount in the flow chart illustrated in FIG. 14 is a realistic calculation amount of (x_A+y_A)*(x_B+y_B).

Thus, in the second embodiment, the area may be identified through a calculation process lighter than that of the comparative example.

Next, a specific third embodiment for the network group determination device, the network group determination method and the storage medium that stores the network group determination program will be described below.

This third embodiment also is equivalent to an example of each of the first application mode and the second application mode described above. Further, this third embodiment is also equivalent to an example of a third application mode preferable with respect to the basic mode.

With respect to the basic mode, the third application mode, in which the first communication information, the second communication information and the third communication information are Hops numbers (the number of hops), is preferable. The information of the Hops number (the number of hops) used in this third application mode is information that represents, with an integer value, a distance of communication, and the number of digits of the integer value is generally small and therefore, information comparison for area determination is simplified.

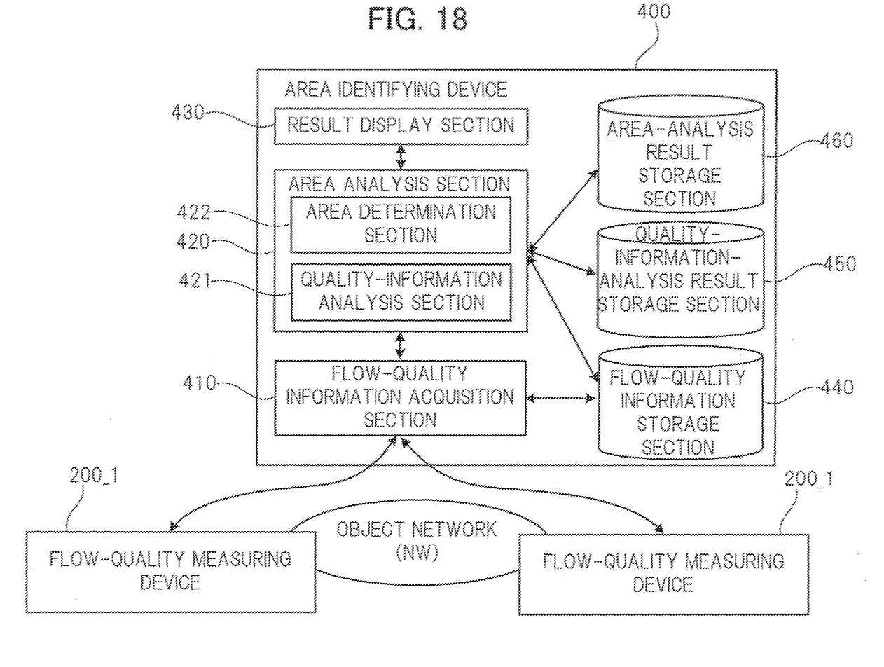

FIG. 18 is a diagram that illustrates an area identifying device corresponding to the third embodiment of the network group determination device.

This area identifying device (400) is connected to plural flow-quality measuring devices 200_1. Further, these flow-quality measuring devices 200_1 are connected to the above-described object network.

The flow-quality measuring device 200_1 is a device that measures RTT and Hops number as flow quality in communication performed on the object network. The structure of the flow-quality measuring device 200_1 is similar to the structure in the second embodiment and thus, overlapping description will be omitted.

Here, a method of measuring the Hops number will be described. The Hops number is the number of repeaters through which a communication packet has passed. In this third embodiment, the Hops number is measured as follows by the life time 13 of the IP header 10 illustrated in FIG. 10.

When a communication packet is transmitted from a device with a source address, this life time 13 is set to, for example, a predetermined initial value such as “255”, “128” and “64”. This life time 13 is reduced only by one, each time the life time 13 is overwritten by the repeater whenever the repeater is passed through. A NW (network) having the Hops number of 20 or more is generally extremely rare. Therefore, a difference between a value of the life time 13 at the time of arrival in the repeater in the network monitoring point and each initial value is obtained, and one having a difference of 1 through 20 is selected, and thereby the number of times when the communication packet has passed through the repeater, namely, the Hops number, is estimated. Such Hops number also is a numerical value that represents a distance of communication, but the Hops number represents a distance of communication from a point of view different from the RTT. Thus, the Hops number and the RTT are closely correlated with each other, but are not in a complete cause-and-effect relation.

The description will be continued as follows by returning to FIG. 18.

This the area identifying device 400 includes a flow-quality information acquisition section 410, an area analysis section 420, a result display section 430, a flow-quality information storage section 440, a quality-information-analysis result storage section 450 and an area-analysis result storage section 460. Further, the area analysis section 420 includes a quality-information analysis section 421 and an area determination section 422. The hardware configuration of the area identifying device 400 is similar to the hardware configuration of the area identifying device 100 of the second embodiment and thus, detailed description will be omitted.

The flow-quality information acquisition section 410 collects measured data of RTT and Hops number as flow quality information, from each of the plural flow-quality measuring devices 200_1. This flow-quality information acquisition section 410 is equivalent to an example of the acquisition section in the basic mode described above. The flow quality information collected by the flow-quality information acquisition section 410 is stored in the flow-quality information storage section 440.

The area analysis section 420 analyzes an area to which the specific communication location belongs, based on the flow quality information stored in the flow-quality information storage section 440. The quality-information analysis section 421 of the area analysis section 420 uses pieces of the measured data of RTT and Hops number individually, thereby performing an area analysis. Further, the area determination section 422 integrates results of the individual analyses in the quality-information analysis section 421, thereby determining the area to which the communication location belongs. The analysis result obtained by the quality-information analysis section 421 is stored in the quality-information-analysis result storage section 450. Further, the determination result obtained by the area determination section 422 is stored in the area-analysis result storage section 460. This quality-information analysis section 421 is equivalent to an example of the comparison section in the basic mode. Further, the quality-information analysis section 421 and the area determination section 422 combined is equivalent to an example of the determination section in the basic mode. The analysis by this area analysis section 420 will be described later in detail.

The result display section 430 displays the analysis result stored in the area-analysis result storage section 460. This result display section 430 is equivalent to an example of the display section in the above-described second application mode.

Here, an area identification program for causing a computer to operate as the area identifying device 400 will be described. This area identification program is equivalent to the program stored in the storage medium that stores the network group determination program according to the third embodiment.

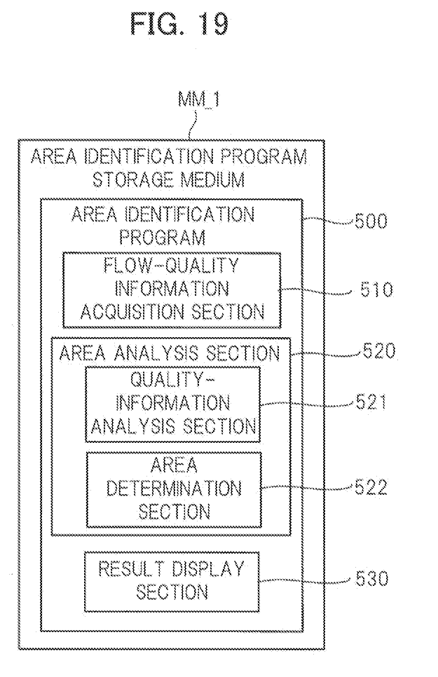

FIG. 19 is a diagram that illustrates the area identification program according to the third embodiment.

This area identification program (500) is stored in the area-identification program storage medium MM_1. The area identification program 500 is taken into the computer from the area-identification program storage medium MM_1.

This area-identification program storage medium MM_1 may be anything that stores the area identification program 500, like the area-identification program storage medium MM_1 in the second embodiment.

Further, the area identification program 500 of the third embodiment may be taken into the computer from a telecommunication network without going through a storage medium.

As illustrated in FIG. 19, the area identification program 500 includes a flow-quality information acquisition section 510, an area analysis section 520 and a result display section 530. Further, the area analysis section 520 includes a quality-information analysis section 521 and an area determination section 522.

The flow-quality information acquisition section 510 of the area identification program 500 causes the computer to operate as the flow-quality information acquisition section 410 of the area identification device 400. The area analysis section 520 of the area identification program 500 causes the computer to operate as the area analysis section 420 of the area identification device 400. The result display section 530 of the area identification program 500 causes the computer to operate as the result display section 430 of the area identifying device 400. Still furthermore, the quality-information analysis section 521 and the area determination section 522 of the area identification program 500 cause the computer to operate as the quality-information analysis section 421 and the area determination section 422 of the area identification device 400, respectively.

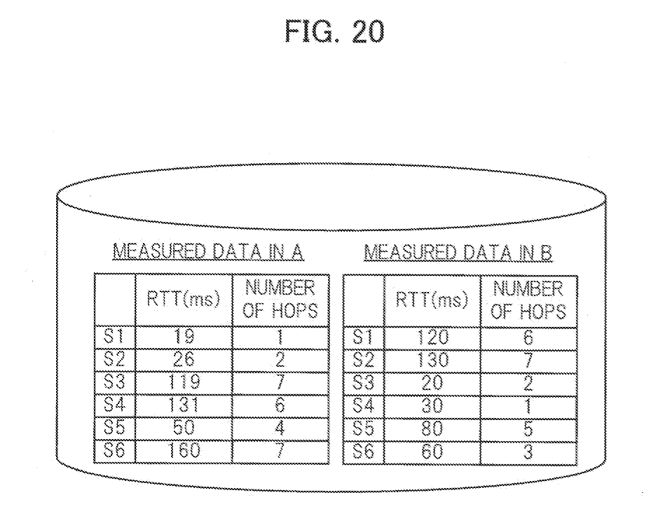

FIG. 20 is a diagram that illustrates an example of the flow quality information stored in the flow-quality information storage section according to the third embodiment.

FIG. 20 illustrates the flow quality information collected in the flow-quality information storage section 440 of the area identification device 400, from each of the flow-quality measuring devices 200_1 illustrated in FIG. 18.

As illustrated in FIG. 20, the flow quality information is stored as a table in which data is associated with each of the end subnets S1 through S6. Further, in this third embodiment, measured data of RTT and measured data of Hops number are stored as the flow quality information.

Next, operation for identifying areas of the end subnets S1 through S6 by the area identifying device 400 illustrated in FIG. 18 will be described in detail.

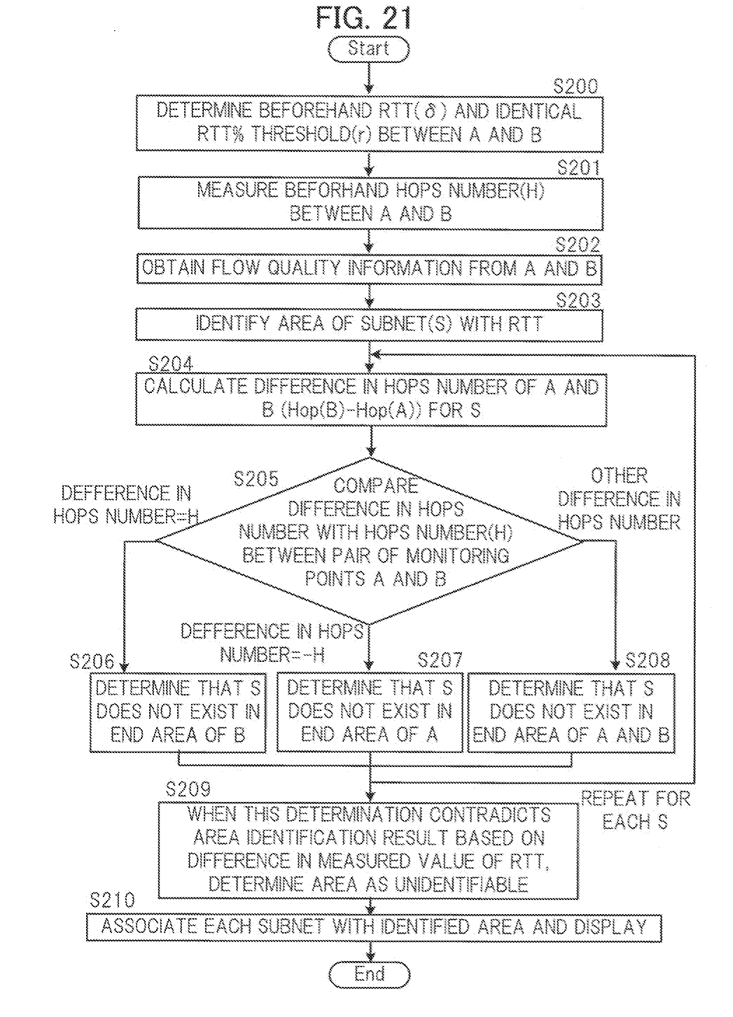

FIG. 21 is a flow chart that represents the operation of the area identification device of the third embodiment.

This flow chart also represents the third embodiment of the network group determination method.

At first, in step S200, in the same way as step S101 of FIG. 14, a measured value δ and a threshold r of RTT between the repeater “A” and the repeater “B” are stored in the flow-quality information storage section 440.

In the next step S201, a Hops number H between the repeater “A” and the repeater “B” is stored in the flow-quality information storage section 440. This Hops number also is measured beforehand by a user of the area identifying device 400 by use of an arbitrary technique.

In the next step S202, the flow quality information is transmitted from the flow-quality measuring device 200_1, and the transmitted measured data is acquired by the flow-quality information acquisition section 410. The acquired flow quality information is stored in the flow-quality information storage section 440 as mentioned above.

Afterwards, processing in each of steps S203 through S208 is executed by the quality-information analysis section 421 of the area identifying device 400.

In step S203, an area analysis based on the measured data of RTT is performed by the processing similar to the processing of step S103 through step S113 in FIG. 14. However, the analysis result obtained in this step S203 is stored in the quality-information-analysis result storage section 450.

The subsequent step S204 through step S208 are repeatedly executed for each end subnet S. At first, in step S204, a difference of the measured data of Hops number is calculated for the end subnet. The sign of this difference will have a role later and thus, in step S204, a difference is determined by subtracting the measured data in the repeater “A” from the measured data in the repeater “B”. In the next step S205, the thus-calculated difference is compared with the Hops number H stored in the flow-quality information storage section 440 in step S201. The Hops number is a not-so-large integer value and thus, an allowable error is not used in the comparison of the Hops number.

When, as a result of the comparison in step S205, the difference=H is satisfied, the net area to which the end subnet S belongs is identified as not being “NET_3” (namely, “NET_1” or “NET_2”) (step S206). In this case, the absolute value of the difference of the measured data agrees with the Hops number between the repeater “A” and the repeater “B”. The determination principle of the area determination based on the Hops number is similar to the above-described determination principle in the area determination based on RTT. However, as mentioned earlier, the Hops number is a not-so-large integer value and thus, even when the end subnet S belongs to the net area “NET_2”, it is very likely that the difference=H is satisfied accidentally. Thus, when the difference=H is satisfied, in a manner different from the analysis based on RTT, identification is made loosely such that the net area is something other than the opposite end area.

When, as a result of the comparison in step S205, the difference=−H is satisfied, the net area to which the end subnet S belongs is identified as not being “NET_1” (namely, “NET_2 or “NET_3”) (step S207).

When, as a result of the comparison in step S205, the difference agrees with neither H nor −H, the net area to which the end subnet S belongs is identified as “NET_2” (step S208).

The result of the analysis performed in step S204 through step S208 in this way also is stored in the quality-information-analysis result storage section 450.

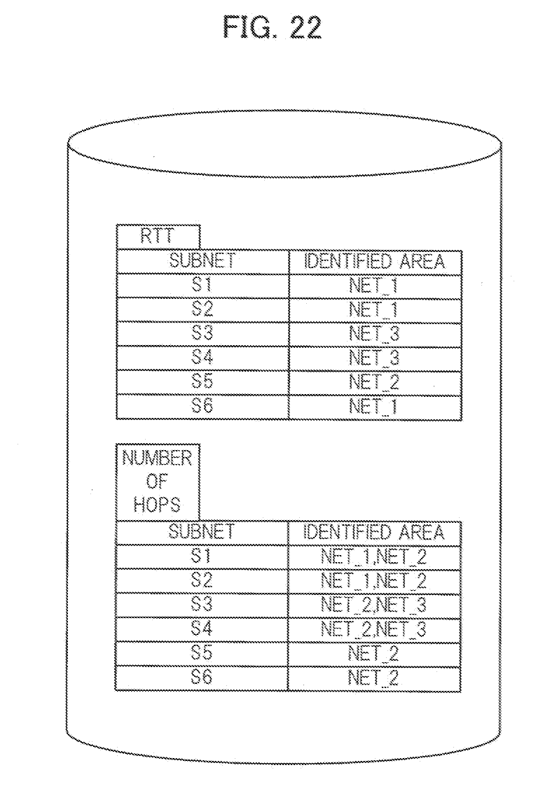

FIG. 22 is a diagram that illustrates an example of the analysis result stored in the quality-information-analysis result storage section according to the third embodiment.

In the quality-information-analysis result storage section 450, as illustrated in FIG. 22, the analysis result is stored in a form of a table where the end subnets and the identified areas are associated with each other. Further, as the table of the analysis result, a table that represents the result of the area analysis based on RTT and a table that represents the result of the area analysis based on Hops number are stored.

Here, each of the end subnets will be described specifically.

At first, the result of the area analysis based on RTT will be described. About δ and r that are preconditions of the analysis, it is also assumed here that δ=100 ms, r=5%.

In the case of the end subnet S1, the calculation results in the difference=120−19=101 based on the measured data illustrated in FIG. 20. The absolute value of the difference falls within the error tolerance of 5% with respect to δ, and the sign of the difference is positive and therefore, the net area to which the end subnet S1 belongs is identified as “NET_1”.

In the case of the end subnet S2, the calculation results in the difference=130−26=104 based on the measured data illustrated in FIG. 20. The absolute value of the difference falls within the error tolerance of 5% with respect to δ, and the sign of the difference is positive and therefore, the net area to which the end subnet S2 belongs is also identified as “NET_1”.

In the case of the end subnet S3, the calculation results in the difference=20−119=−99 based on the measured data illustrated in FIG. 20. The absolute value of the difference falls within the error tolerance of 5% with respect to δ, and the sign of the difference is negative and therefore, the net area to which the end subnet S3 belongs is identified as “NET_3”.

In the case of the end subnet S4, the calculation results in the difference=30−131=−101 based on the measured data illustrated in FIG. 20. The absolute value of the difference falls within the error tolerance of 5% with respect to δ, and the sign of the difference is negative and therefore, the net area to which the end subnet S4 belongs is identified as “NET_3”.

In the case of the end subnet S5, the calculation results in the difference=80−50=30 based on the measured data illustrated in FIG. 20. The absolute value of the difference does not fall within the error tolerance of 5% with respect to δ and thus, the net area to which the end subnet S5 belongs is identified as “NET_2”.

In the case of the end subnet S6, the calculation results in the difference=160−60=100 based on the measured data illustrated in FIG. 20. The absolute value of the difference falls within the error tolerance of 5% with respect to δ, and the sign of the difference is positive and therefore, the net area to which the end subnet S6 belongs is identified as “NET_1”. The true net area to which this end subnet S6 belongs is “NET_2” and therefore, the example described here is an example of false determination.

Next, the result of the area analysis based on Hops number will be described. As for H that is a precondition of the analysis, it is assumed here that H=5.

In the case of the end subnet S1, the calculation results in the difference=6−1=5 based on the measured data illustrated in FIG. 20. The absolute value of the difference is equal to H, and the sign of the difference is positive and therefore, the net area to which the end subnet S1 belongs is identified as “NET_1” or “NET_2”.

In the case of the end subnet S2, the calculation results in the difference=7−2=5 based on the measured data illustrated in FIG. 20. The absolute value of the difference is equal to H, and the sign of the difference is positive and therefore, the net area to which the end subnet S2 belongs is identified as “NET_1” or “NET_2”.

In the case of the end subnet S3, the calculation results in the difference=2−7=−5 based on the measured data illustrated in FIG. 20. The absolute value of the difference is equal to H, and the sign of the difference is negative and therefore, the net area to which the end subnet S3 belongs is identified as “NET_2” or “NET_3”.

In the case of the end subnet S4, the calculation results in the difference=1−6=−5 based on the measured data illustrated in FIG. 20. The absolute value of the difference is equal to H, and the sign of the difference is negative and therefore, the net area to which the end subnet S4 belongs is identified as “NET_2” or “NET_3”.

In the case of the end subnet S5, the calculation results in the difference=5−4=1 based on the measured data illustrated in FIG. 20. The absolute value of the difference is different from H and thus, the net area to which the end subnet S5 belongs is identified as “NET_2”.

In the case of the end subnet S6, the calculation results in the difference=3−7=−4 based on the measured data illustrated in FIG. 20. The absolute value of the difference is different from H and thus, the net area to which the end subnet S6 belongs is identified as “NET_2”.

In step S209 of FIG. 21, as for the analysis result thus stored in the quality-information-analysis result storage section 450, the area determination section 422 integrates the result based on RTT and the result based on Hops number. As a method of this integration, the following method is used.

For one end subnet, a group of elements that are the identified areas of several kinds of analysis result (in this third embodiment, the result based on RTT and the result based on Hops number). In the case of the example in FIG. 22, as for the end subnet S1, a group {NET_1} of the results of RTT and a group {NET_1, NET_2} of the results of Hops number are obtained. An integrated set of these groups is determined, and the elements of the obtained integrated set are the identified areas of the analysis results that are integrated with each other. When this integrated set is an empty set, there is a contradiction between the several kinds of analysis result and thus, “unidentifiable” is obtained as an integration result.

The analysis result integrated in step S209 of FIG. 21 is stored in the area-analysis result storage section 460.

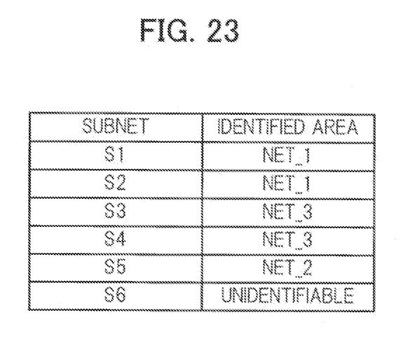

FIG. 23 is a diagram that illustrates an example of the analysis result stored in the area-analysis result storage section according to the third embodiment.

In the area-analysis result storage section 460, as illustrated in FIG. 23, the analysis result is stored in a form of a table where the end subnets and the identified areas are associated with each other. Further, the example illustrated in FIG. 23 is equivalent to the result obtained by integrating the analysis results illustrated in FIG. 22.

In the case of the third embodiment, the identified area is loosely identified in the analysis based on the Hops number and thus, as to the end subnets S1 through S5 in which there is no occurrence of contradiction, the integrated result is equal to the analysis result based on the RTT. On the other hand, as to the end subnet S6 in which there is a contradiction between two kinds of analysis result as a result of a false determination by the analysis based on the RTT, the integrated result is “unidentifiable”.

In step S210 illustrated in FIG. 21, the table as illustrated in FIG. 23 is displayed by the result display section 430 as an analysis result.

As described above, in the third embodiment, as the communication information (the first, the second and the third communication information) in the basic mode, plural kinds of information (namely, here, Hops number and RTT) each of which represents a distance of communication while being provided from different viewpoints are adopted. Further, after the area analyses are individually performed for the respective plural kinds of information, the respective determination results are integrated with each other. When the plural types of communication information are used in this way, the accuracy of the ultimate determination result is improved.

Next, a specific fourth embodiment for the network group determination device, a network group determination method and the network group determination program will be described as follows.

This fourth embodiment also is equivalent to an example of each of the first application mode and the second application mode. Further, this fourth embodiment is equivalent to an example of the following fourth application mode with respect to the basic mode.

In this fourth application mode, the acquisition section acquires: first failure information that represents a trouble in the communication between the first repeater and the network group; and second failure information that represents a trouble in the communication between the second repeater and the network group. Further, in this fourth application mode, as for the result of a determination by the determination section, the first failure information and the second failure information are compared with each other and thereby the success or failure of the result of the determination is decided.

When another expression is used, this fourth application mode may be expressed as one having a failure information acquisition section, a failure information comparison section and a checking section with respect to the basic mode.

The failure information acquisition section acquires the first failure information and the second failure information. This first failure information represents, as a numerical value, an amount of failures occurring in the communication from one of the first repeater and the specific communication location to the other. Further, the second failure information that represents, as a numerical value, an amount of failures occurring in the communication from one of the second repeater and the specific communication location to the other.

The failure information comparison section compares the first failure information with the second failure information.

The checking section checks the success or failure of the determination result obtained by the determination section, based on the comparison result obtained by the failure information comparison section.

According to such a fourth application mode, the accuracy of the ultimate determination is improved by additionally using the failure information whose type is different from the type of the communication information.

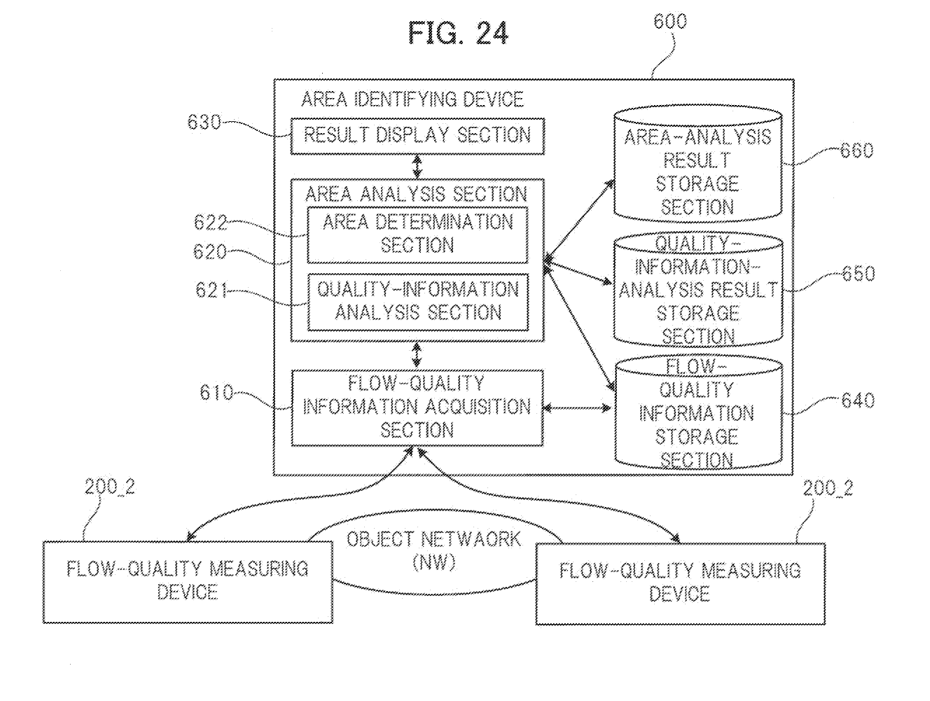

FIG. 24 is a diagram that illustrates an area identifying device corresponding to the fourth embodiment of the network group determination device.

This area identifying device 600 is connected to plural flow-quality measuring devices 200_2. Further the plural flow-quality measuring devices 200_2 are connected to the above-described object network.

Each of the plural flow-quality measuring devices 200_2 is a device that measures RTT and a loss rate as flow quality in communication performed on the object network. The structure of the plural flow-quality measuring device 200_2 is similar to the structure in the second embodiment and thus, overlapping description will be omitted. Further, as to a method of measuring the loss rate as well, an arbitrary measuring method is available among well-known conventional measuring methods and thus will be not specified here in particular.

The measured data of RTT measured in the plural flow-quality measuring devices 200_2 is equivalent to an example of the communication information in the basic mode. On the other hand, the measured data of loss rate measured in the plural flow-quality measuring devices 200_2 is equivalent to an example of the failure information in the fourth application mode.

This area identifying device 600 includes a flow-quality information acquisition section 610, an area analysis section 620, a result display section 630, a the flow-quality information storage section 640, a quality-information-analysis result storage section 650, and an the area-analysis result storage section 660. Further, the area analysis section 620 includes a quality-information analysis section 621 and an area determination section 622. The hardware configuration in this area identifying device 600 is similar to the hardware configuration in the area identifying device 100 of the second embodiment and thus, detailed description will be omitted.

The flow-quality information acquisition section 610 collects the measured data of RTT and loss rate as flow quality information from each of the plural flow-quality measuring devices 200_2. This flow-quality information acquisition section 610 is equivalent to an example of the acquisition section in the basic mode and is also equivalent to an example of the acquisition section (the failure information acquisition section) in the fourth application mode. The flow quality information collected by the flow-quality information acquisition section 610 is stored in the flow-quality information storage section 640.

The area analysis section 620 analyzes an area to which the specific communication location belongs, based on the flow quality information stored in the flow-quality information storage section 640. The quality-information analysis section 621 of the area analysis section 620 uses the measured data of RTT and loss rate individually, thereby performing an area analysis. Further, the area determination section 622 determines the area to which the communication location belongs, by integrating the results analyzed individually in the quality-information analysis section 621. The analysis result obtained by the quality-information analysis section 621 is stored in the quality-information-analysis result storage section 650. Furthermore, the determination result obtained by the area determination section 622 is stored in the area-analysis result storage section 660. This quality-information analysis section 621 is equivalent to an example serving as the comparison section and the determination section in the basic mode. The quality-information analysis section 621 is also equivalent to an example of the failure information comparison section in the fourth application mode described above. Moreover, the area determination section 622 is equivalent to an example of the checking section in the fourth application mode. The analysis by this the area analysis section 620 will be described later in detail.

The result display section 630 displays the analysis result stored in the area-analysis result storage section 660. The result display section 630 is equivalent to an example of the display section in the second application mode.

Here, an area identification program that causes a computer to operate as the area identifying device 600 will be described. This area identification program is equivalent to the program stored in the storage medium that stores the network group determination program according to the fourth embodiment.

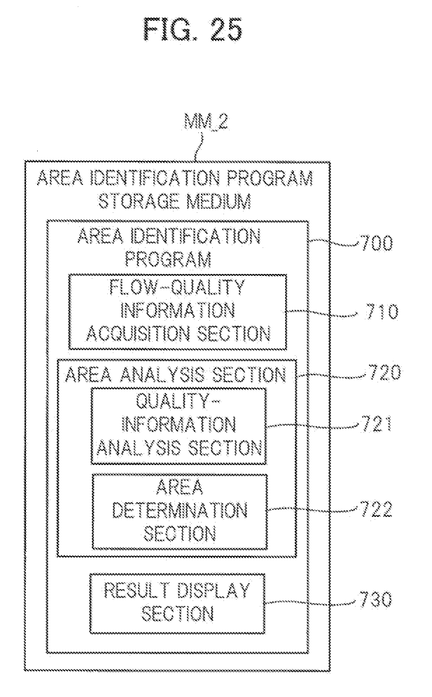

FIG. 25 is a diagram that illustrates the area identification program corresponding to the network group determination program according to the fourth embodiment.

This area identification program (700) is stored in an area-identification program storage medium MM_2. The area identification program 700 is taken into the computer from the area-identification program storage medium MM_2.

This area-identification program storage medium MM_2 may be anything that stores the area identification program 700, like the area-identification program storage medium MM_1 in the second embodiment.

The area identification program 700 of the fourth embodiment may be taken into the computer from a telecommunication network without going through a storage medium.

As illustrated in FIG. 25, the area identification program 700 includes a flow-quality information acquisition section 710, an area analysis section 720, and a result display section 730. Further, the area analysis section 720 includes a quality-information analysis section 721 and an area determination section 722.

The flow-quality information acquisition section 710 of the area identification program 700 causes the computer to operate as the flow-quality information acquisition section 610 of the area identification device 600. The area analysis section 720 of the area identification program 700 causes the computer to operate as the area analysis section 620 of the area identification device 600. The result display section 730 of the area identification program 700 causes the computer to operate as the result display section 630 of the area identifying device 600. The quality-information analysis section 721 and the area determination section 722 of the area identification program 700 cause the computer to operate as the quality-information analysis section 621 and the area determination section 622 of the area identification device 600, respectively.

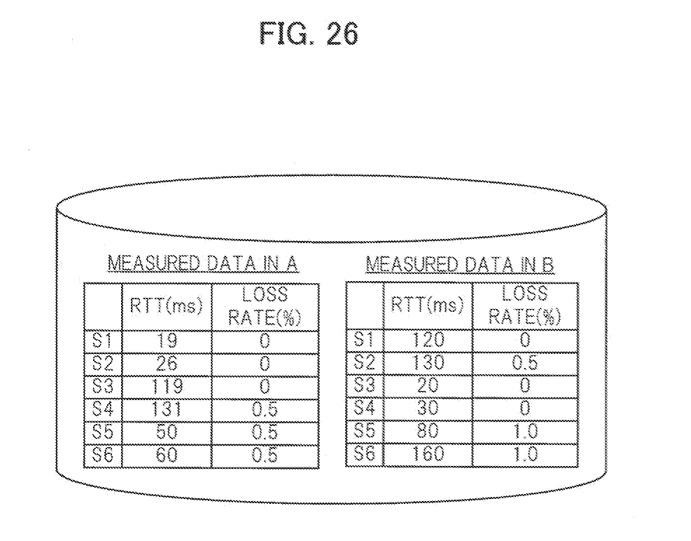

FIG. 26 is a diagram that illustrates an example of the flow quality information stored in the flow-quality information storage section according to the fourth embodiment.

FIG. 26 illustrates the flow quality information collected in the flow-quality information storage section 640 of the area identification device 600 from each of the plural flow-quality measuring devices 200_2 illustrated in FIG. 24.

As illustrated in FIG. 26, the flow quality information is stored as a table where pieces of the data are respectively associated with the end subnets S1 through S6. In this fourth embodiment, the measured data of RTT and the measured data of loss rate are stored as the flow quality information.

Next, operation for identifying the areas of the end subnets S1 through S6 by the area identifying device 600 illustrated in FIG. 24 will be described in detail.

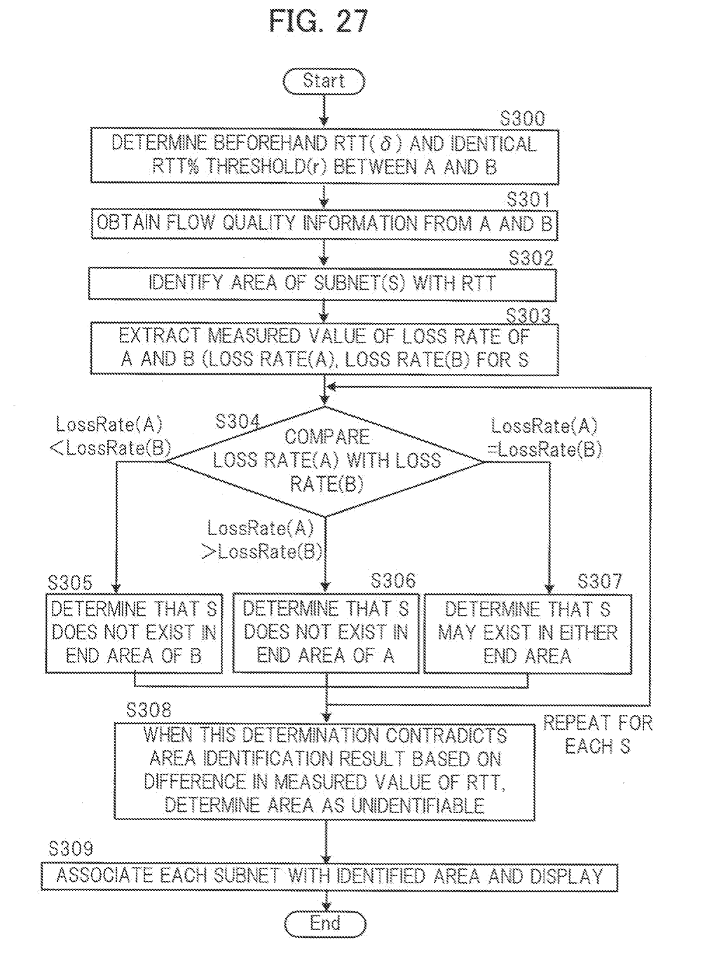

FIG. 27 is a flow chart that represents the operation of the area identification device of the fourth embodiment.

This flow chart also represents the fourth embodiment of the network group determination method.

At first, in step S300, a measured value δ and a threshold r of RTT between the repeater “A” and the repeater “B” are stored in the same way as step S101 of FIG. 14, in the flow-quality information storage section 640.

In the next step S301, the flow quality information is transmitted from the flow-quality measuring device 200_2, and the transmitted measured data is acquired by the flow-quality information acquisition section 610. The acquired flow quality information is stored in the flow-quality information storage section 640 as described above.

Afterwards, processing in each of step S302 through step S307 is executed by the quality-information analysis section 621 of the area identifying device 600.

In step S302, an area analysis based on the measured data of RTT is performed by processing similar to the processing in step S103 through step S113 of FIG. 14. However, the analysis result obtained in this step S302 is stored in the quality-information-analysis result storage section 650.

The subsequent step S303 through step S307 are repeatedly executed for each end subnet S. At first, in step S303, the measured data of loss rate for the end subnet is read from the flow-quality information storage section 640. In the next step S304, the measured data of loss rate in the repeater “A” and the measured data of loss rate in the repeater “B” are compared with each other.

When, as a result of the comparison in step S304, [loss rate in “A”<loss rate in “B”] is satisfied, the net area to which the end subnet S belongs is determined as not being “NET_3” (namely, “NET_1” or “NET_2”) (step S305). The determination principle of the area determination based on this loss rate is different from the determination principle based on RTT and Hops number described above. Here, as for the loss rate caused for the end subnet existing in the end area, the determination is performed based on the principle in which the loss rate of the “frontward” repeater is smaller than the loss rate of the “distant” repeater, and the reverse does not occur.

When, as a result of the comparison in step S304, [loss rate in “A”>loss rate in “B”] is satisfied, the net area to which the end subnet S belongs is determined as not being “NET_1” (namely, “NET_2” or “NET_3”) (step S306).

When, as a result of the comparison in step S304, [loss rate in “A”=loss rate in “B”] is satisfied, it is determined that the end subnet S may exist in any of the net areas (step S307).

The result of the analysis thus performed in step S303 through step S307 also is stored in the quality-information-analysis result storage section 650.

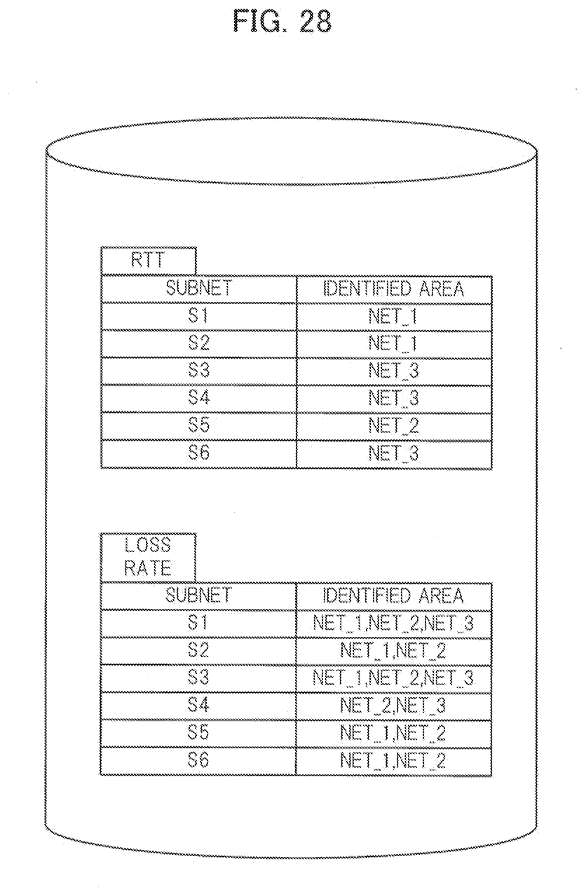

FIG. 28 is a diagram that illustrates an example of the analysis result stored in the quality-information-analysis result storage section according to the fourth embodiment.

In the quality-information-analysis result storage section 650, as illustrated in FIG. 28, the analysis result is stored in a form of a table where the end subnets and the identified areas are associated with each other. Further, as the table of the analysis result, a table that represents the result of the area analysis based on RTT and a table that represents the result of the area analysis based on loss rate are stored.

Here, each of the end subnets will be described specifically.

At first, the result of the area analysis based on RTT will be described. About δ and r that are preconditions of the analysis, it is also assumed here that δ=100 ms, r=5%.

In the case of the end subnet S1, the calculation results in the difference=120−19=101 based on the measured data illustrated in FIG. 26. The absolute value of the difference falls within the error tolerance of 5% with respect to δ, and the sign of the difference is positive and therefore, the net area to which the end subnet S1 belongs is identified as “NET_1”.

In the case of the end subnet S2, the calculation results in the difference=130−26=104 based on the measured data illustrated in FIG. 26. The absolute value of the difference falls within the error tolerance of 5% with respect to δ, and the sign of the difference is positive and therefore, the net area to which the end subnet S2 belongs also is identified as “NET_1”.

In the case of the end subnet S3, the calculation results in the difference=20−119=−99 based on the measured data illustrated in FIG. 26. The absolute value of the difference falls within the error tolerance of 5% with respect to δ, and the sign of the difference is negative and therefore, the net area to which the end subnet S3 belongs is identified as “NET_3”.

In the case of the end subnet S4, the calculation results in the difference=30−131=−101 based on the measured data illustrated in FIG. 26. The absolute value of the difference falls within the error tolerance of 5% with respect to δ, and the sign of the difference is negative and therefore, the net area to which the end subnet S4 belongs is identified as “NET_3”.

In the case of the end subnet S5, the calculation results in the difference=80−50=30 based on the measured data illustrated in FIG. 26. The absolute value of the difference does not fall within the error tolerance of 5% with respect to δ and thus, the net area to which the end subnet S5 belongs is identified as “NET_2”.

In the case of the end subnet S6, the calculation results in the difference=60−160=−100 based on the measured data illustrated in FIG. 26. The absolute value of the difference falls within the error tolerance of 5% with respect to δ, and the sign of the difference is negative and therefore, the net area to which the end subnet S6 belongs is identified as “NET_3”. The true net area to which this end subnet S6 belongs is “NET_2” and thus, the example described here is an example of a false determination.

Next, the result of the area analysis based on the loss rate will be described.

In the case of the end subnet S1, the comparison result is 0=0 based on the measured data illustrated in FIG. 26. For this reason, the net area to which the end subnet S1 belongs is determined as “NET_1”, or “NET_2”, or “NET_3”.

In the case of the end subnet S2, the comparison result is 0<0.5 based on the measured data illustrated in FIG. 26. For this reason, the net area to which the end subnet S2 belongs is determined as “NET_1” or “NET_2”.

In the case of the end subnet S3, the comparison result is 0=0 based on the measured data illustrated in FIG. 26. For this reason, the net area to which the end subnet S3 belongs is determined as “NET_1”, or “NET_2”, or “NET_3”.

In the case of the end subnet S4, the comparison result is 0.5>0 based on the measured data illustrated in FIG. 26. For this reason, the net area to which the end subnet S4 belongs is determined as “NET_2” or “NET_3”.

In the case of the end subnet S5 and S6, the comparison result is 0.5<1.0 based on the measured data illustrated in FIG. 26 in either case. For this reason, the net area to which the end subnet S5, S6 belongs is determined as “NET_1” or “NET_2”.

In step S308 of FIG. 27, as to the analysis result thus stored in the quality-information-analysis result storage section 650, the area determination section 622 integrates the result based on RTT and the result based on loss rate. The method of integration in this fourth embodiment also is the same as the method of integration in the third embodiment. The analysis result obtained by the integration in this step S308 is stored in the area-analysis result storage section 660.

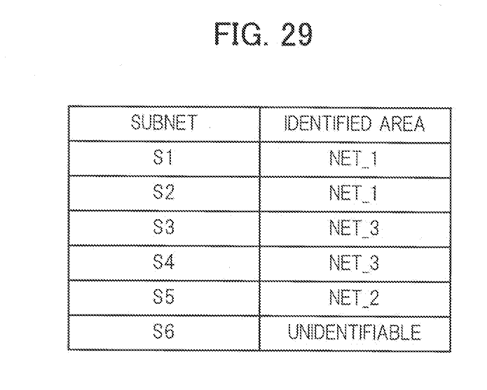

FIG. 29 is a diagram that illustrates an example of the analysis result stored in the area-analysis result storage section according to the fourth embodiment.

In the area-analysis result storage section 660, as illustrated in FIG. 29, the analysis result is stored in a form of a table where the end subnets and the identified areas are associated with each other. Further, the example illustrated in FIG. 29 is equivalent to the result of integrating the analysis results illustrated in FIG. 28.

The identified area is very loosely identified in the analysis based on the loss rate and therefore, as to the end subnets S1 through S5 in which there is no occurrence of contradiction, the result of the integration is equal to the analysis result based on the RTT. On the other hand, as to the end subnet S6 in which there is a contradiction between the two kinds of analysis result due to the false determination in the analysis based on the RTT, the result of the integration is “unidentifiable”. In this way, the information that represents a distance of communication and the information that represents an amount of failures occurring the communication are used together, so that the accuracy of the ultimate area analysis is improved.

In step S309 illustrated in FIG. 27, the table as illustrated in FIG. 29 is displayed by the result display section 630 as an analysis result.

Next, a fifth specific embodiment for the network group determination device, the network group determination method and the storage medium that stores the network group determination program will be described below.

This fifth embodiment also is equivalent to an example of each of the first application mode and the second application mode.

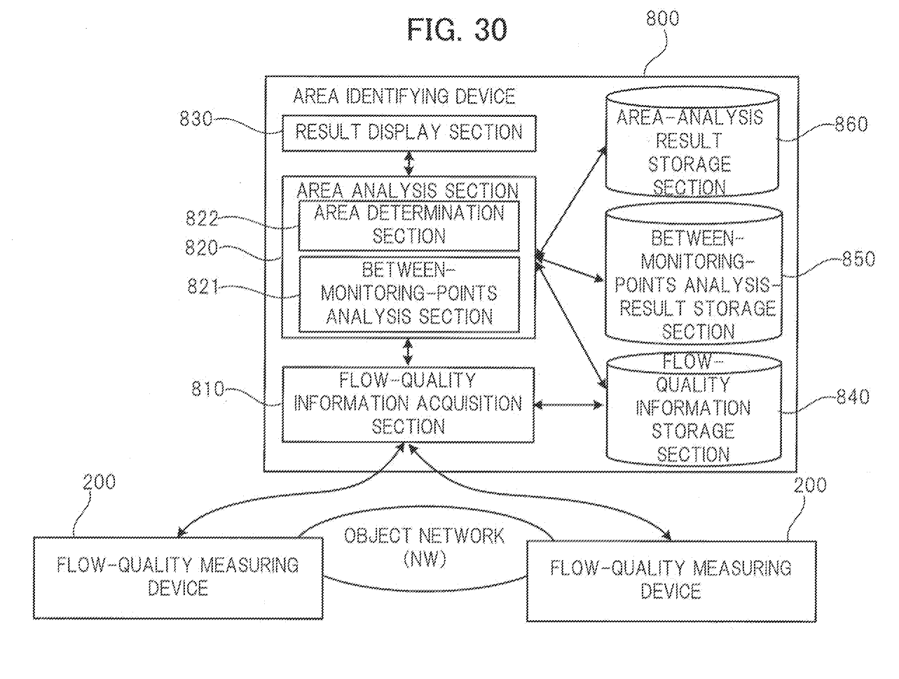

FIG. 30 is a diagram that illustrates an area identifying device corresponding to the fifth embodiment of the network group determination device.

This area identifying device (800) is connected to flow-quality measuring devices 200 similar to the flow-quality measuring devices 200 in the second embodiment.

This area identifying device 800 includes a flow-quality information acquisition section 810, an area analysis section 820, a result display section 830, a flow-quality information storage section 840, a between-monitoring-points analysis-result storage section 850 and, an area-analysis result storage section 860. Further, the area analysis section 820 includes a between-monitoring-points analysis section 821 and an area determination section 822. The hardware configuration in this area identifying device 800 is similar to the hardware configuration in the area identifying device 100 of the second embodiment and thus, detailed description will be omitted.

The flow-quality information acquisition section 810 in this fifth embodiment is the same as the flow-quality information acquisition section 110 in the second embodiment. However, in this fifth embodiment, the flow quality information is collected from the three or more flow-quality measuring devices 200 connected to the three or more repeaters, respectively. This flow-quality information acquisition section 810 also is equivalent to an example of the acquisition section in the basic mode.

The area analysis section 820 analyzes an area to which the specific communication location belongs, based on the flow quality information (measured data of RTT) stored in the flow-quality information storage section 840. The between-monitoring-points analysis section 821 of the area analysis section 820 analyzes an area in a manner similar to the analysis method in the second embodiment, for each pair of repeaters (namely, network monitoring points). The area determination section 822 of the area analysis section 820 determines an area to which the communication location belongs, by integrating the analysis results obtained by the area analyses of the respective pairs of repeaters. The analysis result obtained by the between-monitoring-points analysis section 821 is stored in the between-monitoring-points analysis-result storage section 850. Further the determination result obtained by the area determination section 822 is stored in the area-analysis result storage section 860. This between-monitoring-points analysis section 821 is equivalent to an example of the comparison section in the basic mode. Furthermore, the between-monitoring-points analysis section 821 and the area determination section 822 combined is equivalent to an example of the determination section in the basic mode.

The result display section 830 displays the analysis result stored in area-analysis result storage section 860. The result display section 830 is equivalent to an example of the display section in the second application mode.

Here, an area identification program that causes a computer to operate as the area identifying device 800 will be described. This area identification program is equivalent to an example of the network group determination program according to the fifth embodiment.

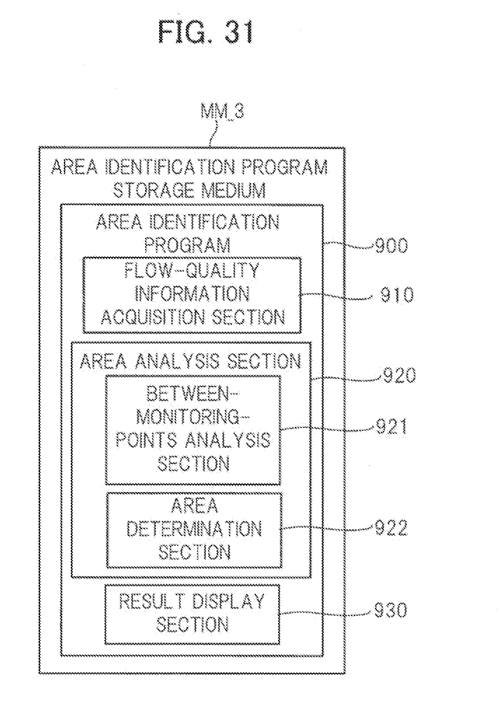

FIG. 31 is a diagram that illustrates the area identification program corresponding to the network group determination program according to the fifth embodiment.

This area identification program (900) is stored in an area-identification program storage medium MM_3. And the area identification program 900 is taken into the computer from the area-identification program storage medium MM_3.

This area-identification program storage medium MM_3 may be anything that stores the area identification program 900, like the area-identification program storage medium MM_1 in the second embodiment.

The area identification program 900 of the fifth embodiment also may be taken from a telecommunication network without going through a storage medium.

As illustrated in FIG. 31, the area identification program 900 includes a flow-quality information acquisition section 910, an area analysis section 920, and a result display section 930. Further, the area analysis section 920 includes a between-monitoring-points analysis section 921 and an area determination section 922.

The flow-quality information acquisition section 910 of the area identification program 900 causes the computer to operate as the flow-quality information acquisition section 810 of the area identification device 800. The area analysis section 920 of the area identification program 900 causes the computer to operate as the area analysis section 820 of the area identification device 800. The result display section 930 of the area identification program 900 causes the computer to operate as the result display section 830 of the area identifying device 800. The between-monitoring-points analysis section 921 and the area determination section 922 of the area identification program 900 causes the computer to operate as the between-monitoring-points analysis section 821 and the area determination section 822 of the area identification device 800, respectively.

Here, a concept of the area division in this fifth embodiment will be described.

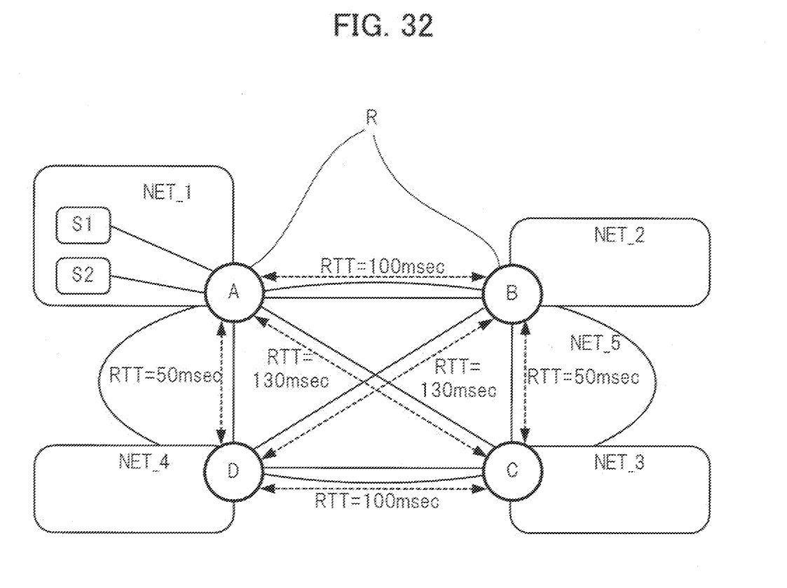

FIG. 32 is a diagram that illustrates the concept of the area division in the fifth embodiment.

In this fifth embodiment as well, the topological area division as described above is adopted, but in this fifth embodiment, the three or more repeaters R are assumed. Four repeaters R are illustrated in the example illustrated in FIG. 32. These four repeaters R are distinguished from each other by being referred to as a repeater “A”, a repeater “B”, a repeater “C”, and a repeater “D”. When the area division is topologically performed as described above, by using these four repeaters R, the object network is divided into five net areas of “NET_1”, “NET_2”, “NET_3”, “NET_4”, and “NET_5”. The flow quality information (namely, measured data of RTT) is obtained in the measurement in each of these four repeaters R, the obtained measured data is collected by the flow-quality information acquisition section 810.

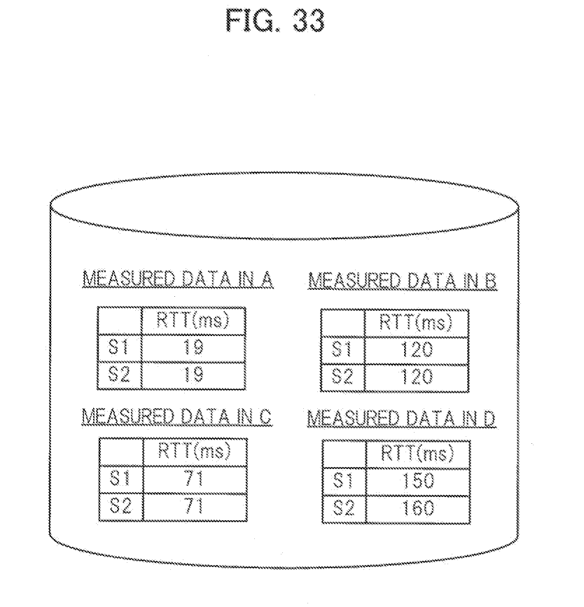

FIG. 33 is a diagram that illustrates an example of the flow quality information stored in the flow-quality information storage section according to the fifth embodiment.

In this fifth embodiment as well, like the second embodiment, the measured data of RTT is stored as a table where pieces of the data are associated with the end subnets S1 and S2. Further, in the example illustrated in FIG. 33, the measured data is collected in each of the four repeaters “A”, “B”, “C” and “D”.

Next, operation for identifying the areas of the end subnets S1 and S2 by the area identification device 800 illustrated in FIG. 30, based on the thus collected measured data, will be described in detail.

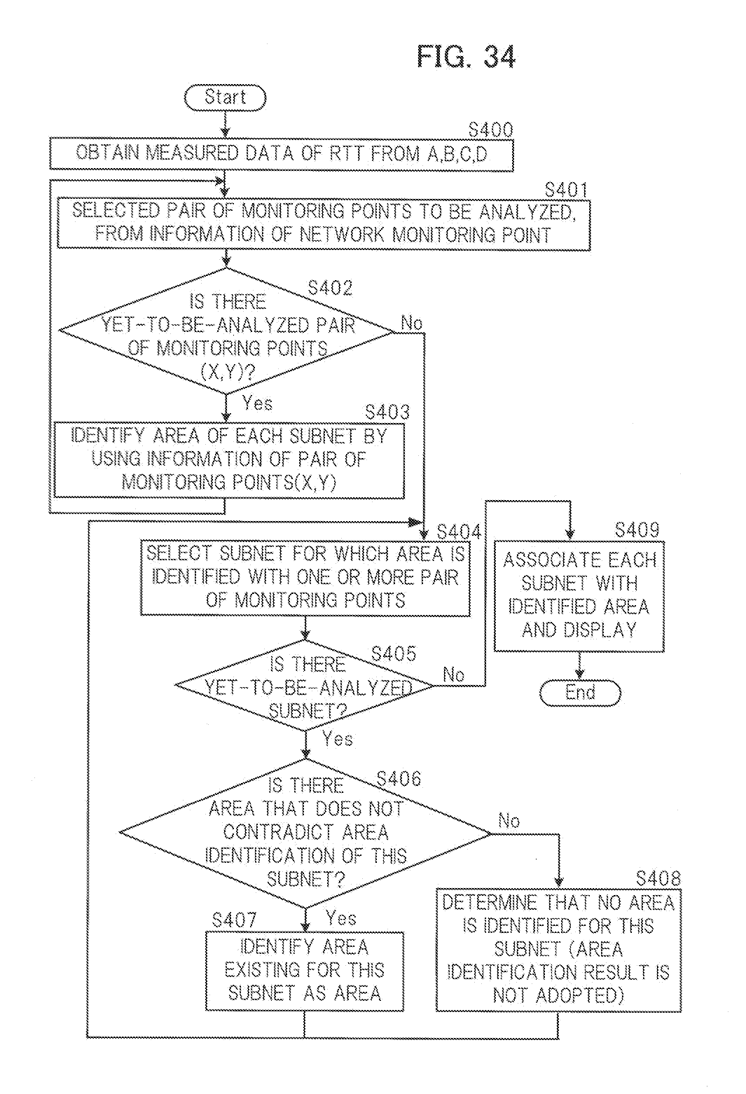

FIG. 34 is a flow chart that represents the operation of the area identification device in the fifth embodiment.

This flow chart also represents the fifth embodiment of the network group determination method.

At first, in step S400, the measured data of RTT is transmitted from each of the flow-quality measuring devices 200 respectively connected to the four repeaters “A”, “B”, “C” and “D”, and the transmitted measured data is acquired by the flow-quality information acquisition section 810. The acquired measured data is stored in the flow-quality information storage section 840 as described above.

In step S401, a pair of repeaters is selected from among the four repeaters “A”, “B”, “C” and “D” by the between-monitoring-points analysis section 821. In this selection, permutations (combinations) of the four repeaters “A”, “B”, “C” and “D” are selected in sequence.

Subsequently, as long as there is a pair of repeaters yet to be subjected to the area analysis (step S402: Yes), the pair of repeaters selected in step S401 is subjected to the area analysis in a manner similar to the second embodiment (step S403). The analysis result obtained in this step S403 is stored in the between-monitoring-points analysis-result storage section 850.

Incidentally, in the area analysis applied to the pair of repeaters, the area division as illustrated in FIG. 32 is reworked to result in the area division as illustrated in FIG. 7. In other words, when a pair of the repeater “B” and the repeater “D” illustrated in FIG. 32 is selected, the “NET_2” illustrated in FIG. 32 corresponds to the “NET_1” illustrated in FIG. 7. Further, the “NET_4” illustrated in FIG. 32 corresponds to the “NET_3” illustrated in FIG. 7. Furthermore, a combination of the “NET_3”, “NET_5” and “NET_1” illustrated in FIG. 32 corresponds to the “NET_2” illustrated in FIG. 7.

An example of the result obtained by performing such reworking of the area for each pair of repeaters and performing the area analysis will be described.

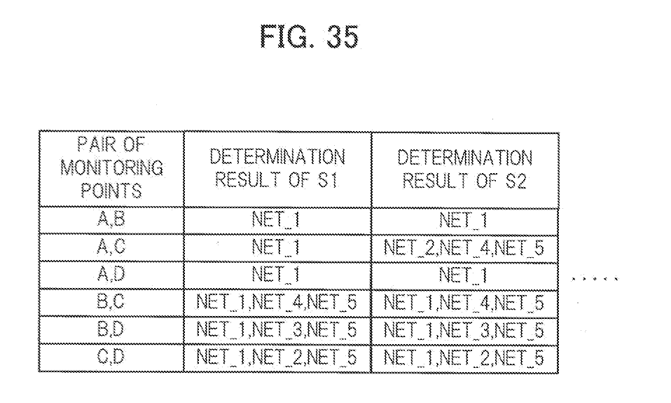

FIG. 35 is a diagram that illustrates an example of the analysis result stored in the between-monitoring-points analysis-result storage section according to the fifth embodiment.

As illustrated in FIG. 35, in the between-monitoring-points analysis-result storage section 850, the identified area for each sub network is associated with the pair of repeaters (namely, the pair of monitoring points).

Each time one cycle of step S401 through step S403 illustrated in FIG. 34 is completed, one stage of the correspondence table illustrated in FIG. 35 is generated. Further, when the area analysis for all the pairs of repeaters (namely, all the pairs of monitoring points) is completed (step S402: No), the flow advances to step S404 in which one line in the table illustrated in FIG. 35 is selected sequentially from the left in sequence by the area determination section 822. In this selection, one with the entire line being “unidentifiable” is excluded. The selected one line represents plural analysis results about a particular end subnet. Subsequently, when the analysis results for the selected one line are not yet integrated (step S405: Yes), the area determination section 822 integrates the analysis results for this one line. In other words, a method of integration that is the same as the method of integration in the third embodiment and the fourth embodiment is used, and whether there is an element of an integrated set (namely, an identified area with no contradiction) is checked (step S406). When there is an identified area with no contradiction, the identified area is stored in the area-analysis result storage section 860 as the last analysis result of the end subnet (step S407).

On the other hand, when there is no identified area with no contradiction as a result of the checking in step S406, a result of “unidentifiable” is stored in the area-analysis result storage section 860 as the last analysis result of the end subnet (step S408).

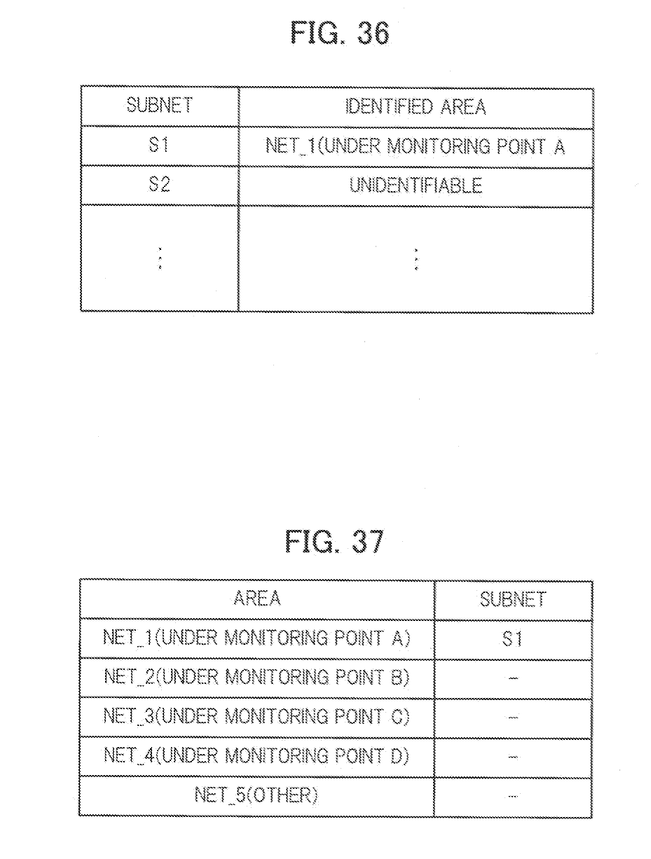

FIG. 36 is a diagram that illustrates an example of the analysis result stored in the area-analysis result storage section according to the fifth embodiment.

As illustrated in FIG. 36, in the fifth embodiment as well, the analysis result is stored in the area-analysis result storage section 860 in a form of a table where the end subnets and the identified areas are associated with each other.

Specifically, in the case of the end subnet S1, “NET_1” is included in any of the analysis results for one line illustrated in FIG. 35 and thus, “NET_1” is an identified area in the table of FIG. 36. Further, in the case of the end subnet S2, a net area included in any of the analysis results for one line illustrated in FIG. 35 does not exist. For this reason, the identified area of the end subnet S2 is “unidentifiable” in the table of FIG. 36.

When such integration of analysis results advances for each line in FIG. 35, ultimately in step S405 of FIG. 34, it is determined that a yet-to-be-analyzed subnet does not exist and the flow proceeds to step S409. In this step S409, the table illustrated in FIG. 36 is displayed by the result display section 830 as an analysis result.

Incidentally, as a display style of the analysis result by the result display section 830, another style is conceivable.

FIG. 37 is a diagram that illustrates another style in the display of the analysis result by the result display section.

In the style illustrated in FIG. 37, a table where the five net areas assumed in FIG. 32 are associated with the end subnets that belong to the respective five net areas is displayed. In the case of such a style, it is easy to remember the area division assumed in FIG. 32 and thus, the location of each end subnet on the network is easy to understand.

In each of the embodiments described above, the end subnet is adopted as the communication location (network group) to be targeted for the analysis of the net area. However, the communication location (network group) targeted for the area determination in the basic mode may be each communication device (e.g. a single computer) on the network.

Further, in each of the embodiments described above, when measuring the communication information of the end subnet, the measured value obtained from the communication with which an arbitrary device included in the end subnet is concerned is used as the measured value for the end subnet. However, in the basic mode described above, one device in the end subnet may be identified, and only a measured value obtained from the communication with which the identified device is concerned may be used as the measured value for the end subnet.

Furthermore, in each of the embodiments described above, the example of displaying the area analysis result in the form of a table has been used. However, as for the display section in the second application mode, when drawing of the position of the communication location is adopted, easy visual understanding is achieved, which is desirable. When the position is drawn in this way, as a concrete drawing method of the display section, for example, it is conceivable to use such a drawing method that conceptual area sections as illustrated in a lower part of FIG. 7 are drawn, and the end subnets are arranged in the drawn area sections. Further, as another drawing method, it is conceivable to use such a drawing method that locations where the repeaters are actually present are drawn on a map, lines passing through the repeaters are drawn on the map to form area sections, and the end subnets are arranged in the area sections.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A network group determination device comprising:
an acquisition section that acquires first communication information which represents a state of communication between a first repeater on a network and a specific network group on the network, and second communication information which represents a state of communication between a second repeater on the network and the network group;
a comparison section that makes a comparison of a difference between the first communication information and the second communication information to third communication information between the first repeater and the second repeater; and
a determination section that makes, according to a result of the comparison by the comparison section, a determination of a position of the network group with respect to the first repeater and the second repeater.

2. The network group determination device according to claim 1, wherein each of the first communication information, the second communication information and the third communication information is a Round Trip Time.

3. The network group determination device according to claim 1, wherein each of the first communication information, the second communication information and the third communication information is a Hops number.

4. The network group determination device according to claim 1, further comprising a display section that draws the position of the network group.

5. The network group determination device according to claim 1, wherein
the acquisition section acquires first failure information which represents a trouble in the communication between the first repeater and the network group, and second failure information which represents a trouble in the communication between the second repeater and the network group, and
as for a result of the determination by the determination section, the first failure information and the second failure information are compared with each other, and thereby success or failure of the result of the determination is decided.

6. The network group determination device according to claim 1, wherein each of the first communication information and the second communication information indicates a state of communication with one communication device which belongs to the network group.

7. A network group determination method comprising:
collecting first communication information which represents a state of communication between a first repeater on a network and a specific network group on the network and transmitting the first communication information to a network group determination device, by a first measuring device;
collecting second communication information which represents a state of communication between a second repeater on the network and the network group and transmitting the second communication information to the network group determination device, by a second measuring device;
making a comparison of a difference between the first communication information and the second communication information to third communication information between the first repeater and the second repeater, by the network group determination device; and
making, according to a result of the comparison, a determination of a position of the network group with respect to the first repeater and the second repeater.

8. The network group determination method according to claim 7, wherein each of the first communication information, the second communication information and the third communication information is a Round Trip Time.

9. The network group determination method according to claim 7, wherein each of the first communication information, the second communication information and the third communication information is a Hops number.

10. A computer-readable, non-transitory medium that stores a network group determination program for causing a computer to execute:
acquiring first communication information which represents a state of communication between a first repeater on a network and a specific network group on the network, and second communication information which represents a state of communication between a second repeater on the network and the network group;
making a comparison of a difference between the first communication information and the second communication information to third communication information between the first repeater and the second repeater; and
making, according to a result of the comparison, a determination of a position of the network group with respect to the first repeater and the second repeater.

11. The medium according to claim 10, wherein each of the first communication information, the second communication information and the third communication information is a Round Trip Time.

12. The medium according to claim 10, wherein each of the first communication information, the second communication information and the third communication information is a Hops number.

13. A network group determination device comprising:
a processor to acquire first communication information which represents a state of communication between a first repeater on a network and a specific network group on the network, and second communication information which represents a state of communication between a second repeater on the network and the network group, to make a comparison of a difference between the first communication information and the second communication information to third communication information between the first repeater and the second repeater, and to make, according to a result of the comparison, a determination of a position of the network group with respect to the first repeater and the second repeater.
